(19) United States
(12) Patent Application Publication
(10) Pub. No.: US 2006/0158373 A1
(43) Pub. Date: Jul. 20, 2006

(54) Positioning apparatus, positioning server apparatus, and positioning system

(75) Inventor: Katsuyuki Kamei, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 11/131,255

(22) Filed: May 18, 2005

(30) Foreign Application Priority Data
Jan. 18, 2005 (JP) 2005-010571

(51) Int. Cl. G01S 5/14

(52) U.S. Cl. 342/357.03; 342/357.09

(57) ABSTRACT

A mobile station (1) is provided having a GPS positioning unit (11) that receives electric waves from GPS satellites and computes the coordinates of an approximate location of a point to be positioned, performs interferometric positioning on the point to be positioned using correction data used for making a correction to the point to be positioned, which are transmitted from a positioning server apparatus (30), so as to compute the coordinates in the world geodetic system of the point to be positioned, and a transformation unit (12) that transforms the coordinates in the world geodetic system of the point to be positioned into those in the existing geodetic system using transformation parameters transmitted from the positioning server apparatus (30) when the coordinates in the world geodetic system of the point to be positioned are located in the interior of a graphic region transmitted from the positioning server apparatus (30).

### BACKGROUND OF THE INVENTION

1. Field of the Invention

The present invention relates to a positioning apparatus, a positioning server apparatus, and a positioning system that determine the current location of a mobile station from electric waves transmitted to the mobile station from GPS (Global Positioning System) satellites.

2. Description of Related Art

In a related art positioning system, the coordinates of the current location of a mobile station, which are computed based on the observation results of the electric waves from the GPS satellites are provided as, for example, three-dimensional coordinates in the world geodetic system, which is called the ITRF94 system, or geographic coordinates including latitude, longitude, and ellipsoid height, which are obtained by transforming the three-dimensional coordinates. However, since points whose location coordinates have been already determined in a past survey have survey errors due to surveys which were done before introduction of the GPS or have moved due to crustal movements which have occurred after the survey, with respect to the world geodetic system, the location of an object which is determined with GPS observations may not conform to the determined coordinates of objects in the vicinity of the object and may not match with the previously-determined location.

For this reason, a related art positioning apparatus according to, for example, a VRS (Virtual Reference Station) method, such as a related art positioning apparatus disclosed in patent reference 1, acquires results of positioning a target in an existing geodetic system on which the coordinates of objects in the vicinity of the target to be positioned are based by transforming the virtual reference point into coordinates in the already-determined existing geodetic system.

A related art positioning system that carries out GPS surveys using this VRS method is comprised of a mobile station which is located at a point to be positioned and performs positioning with GPS, two or more fixed reference stations which are located at two or more fixed reference points, respectively, the coordinates of the locations of the two or more fixed reference stations being known, and a data delivery station which creates correction observation data from observation data obtained by the fixed reference stations, and which delivers the correction observation data to the mobile station.

The data delivery station makes a correction to observation data obtained by each fixed reference station by taking, for example, the natural conditions of ionosphere and troposhere in the sky, and fluctuations of the satellites' orbits and variations in the clock into consideration, assumes a virtual reference point in the vicinity of the point to be positioned which the mobile station locations, and generates virtual observation data about the virtual reference point from the corrected observation data. The mobile station compares the virtual observation data about the virtual reference point with the observation data about the point to be positioned, and then computes a baseline vector indicating a displacement from the virtual reference point. The mobile station adds the baseline vector to the coordinates of the virtual reference point so as to acquire the coordinates of the current location of the point to be positioned.

GPS surveys including such the VRS method are described in “New Basic of GPS Survey” written by Atsushi Tsuchiya and Hiromichi Tsuji and issued in 2002 by Japanese Association of Surveyors, for example.

[Patent reference 1] JP,2004-170290,A (see paragraph number 0013)

A problem with the related art positioning system constructed as mentioned above is that while it provides a virtual reference point in an existing geodetic system, the locations of the GPS satellites with respect to the virtual reference point do not agree with their actual arrangement and the coordinates of the point to be positioned are not acquired correctly since the coordinates of the locations of the GPS satellites remains unchanged at those in the world geodetic system. Another problem is that since the observed electric waves from the GPS satellites and the difference among the lengths of paths traveled by the electric waves are used just as they are, the coordinates in the existing geodetic system of the point to be positioned are not acquired correctly.

For example, when the coordinates in the world geodetic system of the virtual reference point agree with those in the existing geodetic system and a difference arises between the coordinates in the world geodetic system of the point to be positioned and those in the existing geodetic system as the point to be positioned is distant from the virtual reference point. The coordinates obtained for the point to be positioned which is distant from the virtual reference point are the coordinates in the world geodetic system, but are not the coordinates in the existing geodetic system. A further problem is that in order to provide the current location of the point to be positioned of a mobile station with correct coordinates in the existing geodetic system, since the mobile station must transmit computed coordinates of the point to be positioned to the data delivery station, and the data delivery station must carry out transformation, which is performed on a virtual reference point, of the computed coordinates of the point to be positioned into the coordinates in the existing geodetic system and send these coordinates back to the mobile station, the amount of traffic increases and it is therefore difficult to carry out simultaneous positioning of two or more mobile stations and continuous positioning of a mobile station.

### SUMMARY OF THE INVENTION

The present invention is made in order to solve the above-mentioned problems, and it is therefore an object of the present invention to provide a positioning apparatus, a positioning server apparatus, and a positioning system which can compute a survey result of determining the location of a point to be positioned with coordinates in an existing geodetic system, without transmitting and receiving coordinates used for making a correction for every point to be positioned.

In accordance with the present invention, there is provided a positioning apparatus including: a GPS positioning unit for computing coordinates of an approximate location of a point to be positioned by receiving electric waves from GPS satellites, for performing interferometric positioning on the point to be positioned using received correction data used for making a correction to the point to be positioned so as to compute the coordinates in the world geodetic system of the point to be positioned; a communications unit for transmitting the coordinates of the approximate location of the point to be positioned computed by the GPS positioning unit, and for receiving the correction data, transformation parameters used for transforming the coordinates in the world geodetic system of the point to be positioned into coordinates in an existing geodetic system of the point to be positioned, and a graphic region including the coordinates of the approximate location of the point to be positioned; and a transformation unit for transforming the coordinates in the world geodetic system of the point to be positioned into the coordinates in the existing geodetic system of the point to be positioned using the transformation parameters received from the communications unit when the coordinates in the world geodetic system of the point to be positioned, which are computed by the GPS positioning unit, are located in an interior of the graphic region received from the communications unit.

As previously mentioned, in accordance with the present invention, as long as the coordinates in the world geodetic system of the point to be positioned computed by the GPS positioning unit are located in the interior of the received graphic region, the transformation unit transforms the coordinates in the world geodetic system of the point to be positioned into the coordinates in the existing geodetic system of the point to be positioned using the received transformation parameters. Therefore, the present invention offers an advantage of being able to use the same transformation parameters for positioning of two or more points to be positioned, and to compute the location of any point to be positioned with the coordinates in the existing geodetic system of the point with a high degree of precision, without increasing the amount of traffic in the communications network.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a positioning system in accordance with embodiment 1 of the present invention;

FIG. 2 is a diagram showing positioning carried out by the positioning system in accordance with embodiment 1 of the present invention;

FIG. 3 is a diagram explaining transformation of the coordinates in the world geodetic system of a point to be positioned of a mobile station in the positioning system in accordance with embodiment 1 of the present invention into the coordinates in an existing geodetic system of the point to be positioned;

FIG. 4 is a diagram showing the coordinates of an approximate location of the point to be positioned which the mobile station transmits to a positioning server apparatus of the positioning system in accordance with embodiment 1 of the present invention;

FIG. 5 is a diagram showing transformation parameters and a graphic region which the positioning server apparatus transmits to the mobile station in the positioning system in accordance with embodiment 1 of the present invention;

FIG. 6 is a flow chart showing a flow of processing carried out by positioning system in accordance with embodiment 1 of the present invention;

FIG. 7 is a diagram explaining transformation of the coordinates in the world geodetic system of a point to be positioned of a mobile station in a positioning system in accordance with embodiment 2 of the present invention into the coordinates in an existing geodetic system of the point to be positioned;

FIG. 8 is a diagram showing the two-dimensional coordinates of an approximate location of the point to be positioned which a positioning server apparatus transmits to the mobile station in the positioning system in accordance with embodiment 2 of the present invention;

FIG. 9 is a diagram showing transformation parameters and a graphic region which the positioning server apparatus transmits to the mobile station in the positioning system in accordance with embodiment 2 of the present invention;

FIG. 10 is a diagram explaining setting of a graphic region by a positioning system in accordance with embodiment 3 of the present invention;

FIG. 11 is a flow chart showing a flow of processing carried out by the positioning system in accordance with embodiment 3 of the present invention;

FIG. 12 is a diagram explaining transformation of the coordinates in the world geodetic system of a point to be positioned of a mobile station in a positioning system in accordance with embodiment 4 of the present invention into the coordinates in an existing geodetic system of the point to be positioned;

FIG. 13 is a diagram explaining a graphic region for use in the positioning system in accordance with embodiment 4 of the present invention;

FIG. 14 is a diagram showing transformation parameters and a graphic region which a positioning server apparatus transmits to the mobile station in the positioning system in accordance with embodiment 4 of the present invention;

FIG. 15 is a flow chart showing a flow of processing carried out by the positioning system in accordance with embodiment 4 of the present invention;

FIG. 16 is a block diagram showing the structure of a positioning system in accordance with embodiment 5 of the present invention;

FIG. 17 is a flow chart showing a flow of processing carried out by the positioning system in accordance with embodiment 5 of the present invention;

FIG. 18 is a flow chart showing a flow of processing carried out by a positioning system in accordance with embodiment 6 of the present invention; and

FIG. 19 is a flow chart showing a flow of processing carried out by a positioning system in accordance with embodiment 7 of the present invention.

### DETAILED DESCRIPTION OF THE PREFERRED EMBODIMENTS

The preferred embodiments of the present invention will be now described with reference to the accompanying drawings.

### Embodiment 1

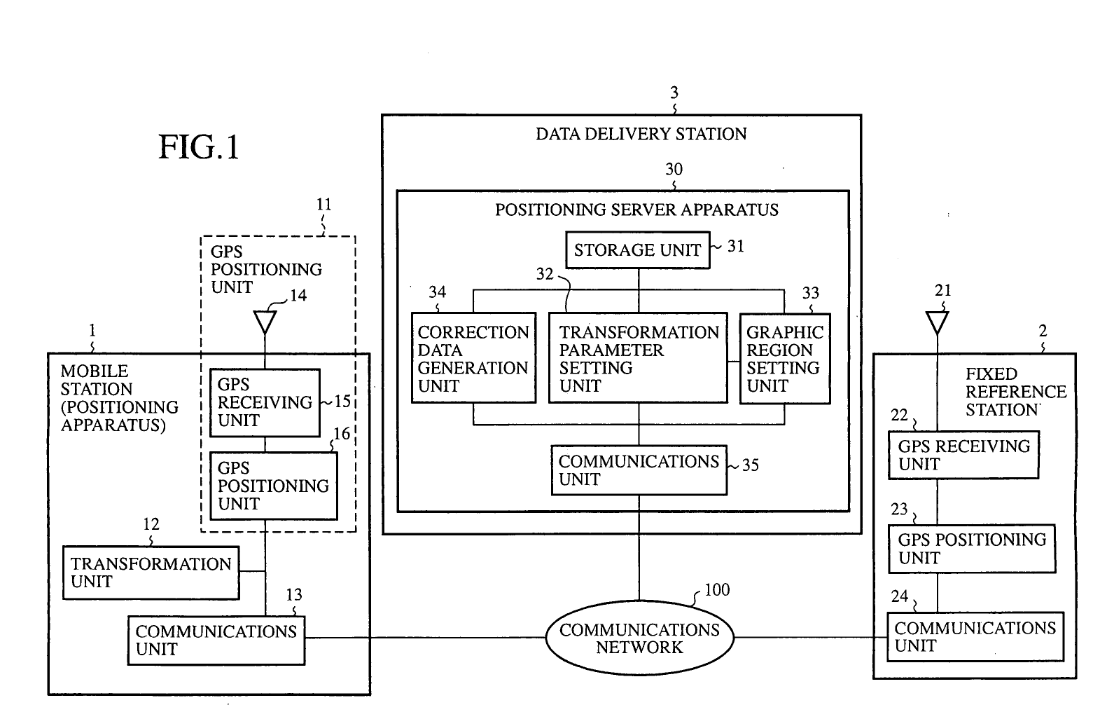

FIG. 1 is a block diagram showing the structure of a positioning system in accordance with embodiment 1 of the present invention. In this positioning system, a mobile station 1 which is a positioning apparatus located at a below-mentioned point to be positioned 101, a fixed reference station 2 located at a below-mentioned fixed reference point 102, and a positioning server apparatus 30 installed in a data delivery station 3 are connected to one another via a communications network 100 which is constructed of a leased line, the Internet, or the like.

In FIG. 1, the mobile station 1 is provided with a GPS positioning unit 11 for determining the location of the mobile station 1 by observing electric waves from GPS satellites, a transformation unit 12 for performing transformation on observed coordinates, and a communications unit 13 including a mobile phone that carries out communications via the communications network 100. The GPS positioning unit 11 is provided with a GPS antenna 14 for receiving the electrics waves from the GPS satellites, a GPS receiving unit 15 for processing signals, and a GPS positioning unit 16 for computing the location of the mobile station 1 from the received signals.

The fixed reference station 2 is provided with a GPS antenna 21 for receiving the electric waves from the GPS satellites, a GPS receiving unit 22 for processing signals, a GPS positioning unit 23 for computing the location of the fixed reference station 2 from the received signals, and a communications unit 24 for carrying out communications via the communications network 100. The positioning server apparatus 30 disposed in the data delivery station 3 is provided with a storage unit 31, a transformation parameter setting unit 32, a graphic region setting unit 33, a correction data generation unit 34, and a communications unit 35 for carrying out communications via the communications network 100.

Information on the fixed reference station 2 is stored in the storage unit 31 of the positioning server apparatus 30. That is, the coordinates in the world geodetic system and the coordinates in an existing geodetic system of the fixed reference point 102 of the fixed reference station 2, and information on a triangular network which is created beforehand and which is defined by coordinates in the world geodetic system are stored in the storage unit 31. This information on the triangular network is comprised of a set of the number of triangular regions, numbers for identifying fixed reference points 102 which constitute each of the plurality of triangular regions, and the coordinates of each vertex of each of the plurality of triangular regions, for example.

This triangular network is created by, for example, selecting those which are operating normally and can carry out communications from among all fixed reference stations 2, and carrying out Delaunay triangulation based on the coordinates in the world geodetic system of the fixed reference points 102 of the selected fixed reference stations. The Delaunay triangulation is carried out in a two-dimensional plane using either the latitude and longitude coordinates or the X and Y coordinates among the coordinates in a plane Cartesian-coordinates system. The selected fixed reference points 102 can also be thinned out. In accordance with this embodiment, although the triangular network is constituted by the coordinates in the world geodetic system of the fixed reference points 102 of the selected fixed reference stations, this triangular network can be alternatively constituted by the coordinates in the existing geodetic system of the fixed reference points 102 of the selected fixed reference stations when the difference between the coordinates in the world geodetic system and those in the existing geodetic system is small.

The transformation parameter setting unit 32 of the positioning server apparatus 30 sets transformation parameters used for transforming the coordinates in the world geodetic system of the point to be positioned 101 into the coordinates in the existing geodetic system of the point to be positioned 101. In accordance with this embodiment 1, the transformation parameter setting unit 32 defines, as transformation parameters, the coordinates in the world geodetic system and those in the existing geodetic system of three fixed reference points 102 which are vertices of a triangular region selected from the triangular network stored in the storage unit 31.

The graphic region setting unit 33 of the positioning server apparatus 30 defines a graphic region which can be properly transformed into coordinates in the existing geodetic system using the transformation parameters set by the transformation parameter setting unit 32. In accordance with this embodiment 1, the graphic region setting unit 33 defines a triangular region which is selected from the triangular network stored in the storage unit 31 as a graphic region.

The correction data generation unit 34 of the positioning server apparatus 30 generates correction data, such as the phases of carriers, indicating amounts of correction for the observed values of the electric waves from the GPS satellites which are used for a GPS survey using a VRS method or a below-mentioned FKP (Flaechen Korrektur Parameter: flat correction parameter) method.

The data delivery station 3 is connected to both the mobile station 1 and the fixed reference station 2 via the communications network 100 which is constructed of a leased line, the Internet, or the like, and transmits and receives data to and from them.

In the positioning system shown in FIG. 1, the mobile station 1 computes the location of the point to be positioned 101 by observing the electric waves from the GPS satellites.

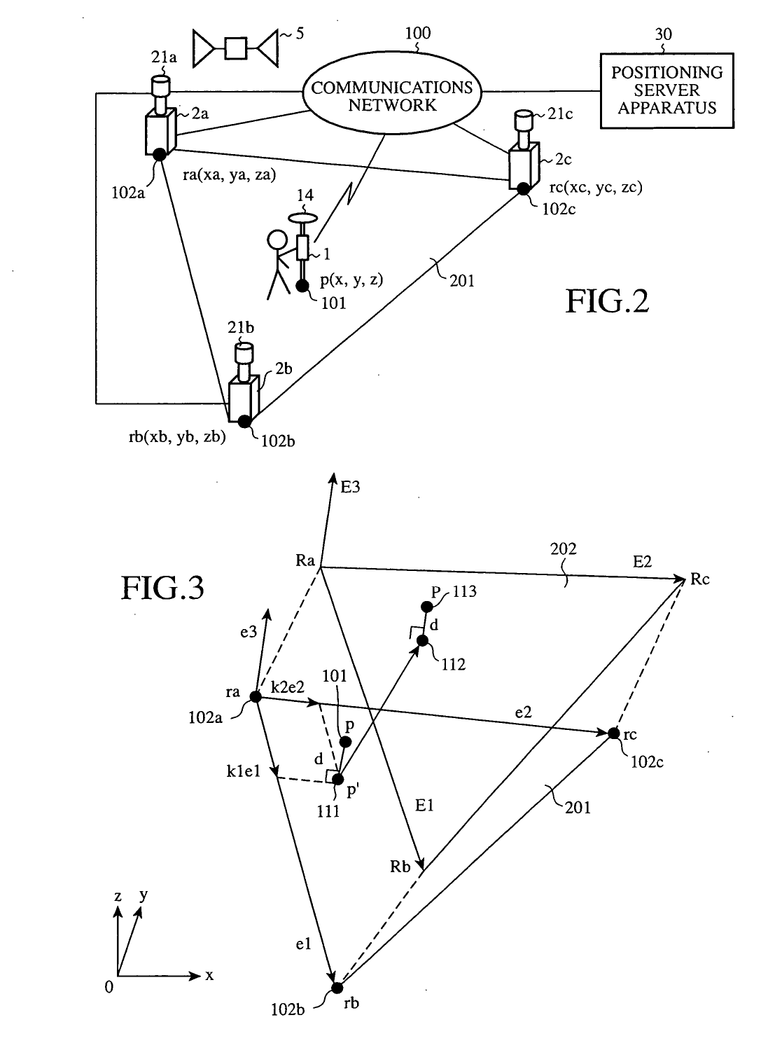

FIG. 2 is a diagram showing the positioning carried out by the positioning system of this embodiment. In FIG. 2, the mobile station 1, fixed reference stations 2a, 2b, and 2c, and the positioning server apparatus 30 are connected to one another via the communications network 100, and the GPS antenna 14 of the mobile station 1 and the GPS antennas 21a, 21b, and 21c of the fixed reference stations 2a, 2b, and 2c receive the electric waves from the GPS satellites 5, respectively. Assume that the coordinates in the world geodetic system of the point to be positioned 101 of the mobile station 1 are p(x, y, z), the coordinates in the world geodetic system of the fixed reference point 102a of the fixed reference station 2a are ra(xa, ya, za), the coordinates in the world geodetic system of the fixed reference point 102b of the fixed reference station 2b is rb (xb, yb, zb), and the coordinates in the world geodetic system of the fixed reference point 102c of the fixed reference station 2c are rc(xc, yc, zc).

FIG. 3 is a diagram for explaining transformation of the coordinates in the world geodetic system of the point to be positioned 101 of the mobile station 1 into the coordinates in the existing geodetic system of the point to be positioned 101. In FIG. 3, ra, rb, and rc indicate the coordinates in the world geodetic system of the fixed reference points 102a, 102b, and 102c, respectively, Ra, Rb, and Rc indicate the coordinates in the existing geodetic system of the fixed reference points 102a, 102b, and 102c, respectively, a triangular region which is constituted by the fixed reference points 102a, 102b, and 102c, and includes the x and y coordinates of the point to be positioned 101 in the interior thereof is defined as a graphic region 201, the coordinates of a point 111 at an end in the graphic region 201 of a perpendicular line which is extending from the point to be positioned 101 having the coordinates p(x, y, z) and which has a right angle with respect to the graphic region 201, the point 111 has a distance d from the point to be positioned 101, are defined as p′, a triangle which consists of the coordinates Ra, Rb, and Rc in the existing geodetic system of the fixed reference points 102a, 102b, and 102c is defined as a graphic region 202, a point on the graphic region 202, which has the coordinates in the existing geodetic system into which the coordinates of the point 111 are transformed is defined as a point 112, and the coordinates of a point 113 which is distant from the point 112 at only the distance d are defined as the coordinates in the existing geodetic system of the point to be positioned 101. Furthermore, e3 (=e1×e2) is a vector perpendicular to the graphic region 201, and E3 (=E1×E2) is a vector perpendicular to the graphic region 202. In accordance with this embodiment 1, since the coordinate transformation is carried out in three dimensions in consideration of the altitude, these vectors e3 and E3 define axes perpendicular to the graphic regions 201 and 202, respectively.

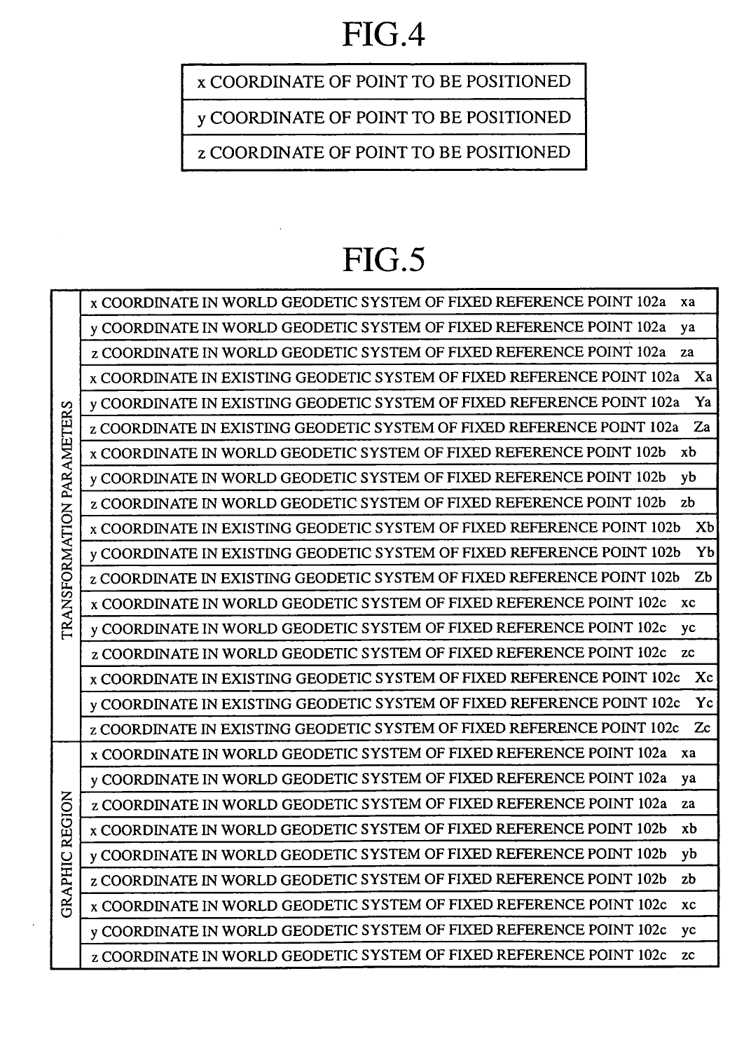

FIG. 4 is a diagram showing the coordinates of an approximate location of the point to be positioned 101 which the mobile station 1 transmits to the positioning server apparatus 30. FIG. 5 is a diagram showing the transformation parameters and the graphic region which the positioning server apparatus 30 transmits to the mobile station 1.

Each fixed reference point 102 is a GPS-based control station provided by the Geographical Survey Institute, for example. The coordinates of the location of each fixed reference point 102 are provided as those defined in the 1997.0 epoch which are called the Japanese Geodetic Datum 2000. For example, the existing geodetic system can be a coordinates system constituted by the coordinates provided by the geodetic survey results 2000. Each fixed reference station 2 is observing the coordinates of the current location thereof in the world geodetic system using a GPS-based positioning method which is called a static positioning method, for example. Generally, the currently-observed coordinates in the world geodetic system of an object are not in agreement with originally-provided those in the existing geodetic system (i.e., those provided by the geodetic survey results 2000) under the influence of diastrophism.

The positioning server apparatus 30 of this embodiment receives the coordinates, as shown in FIG. 4, of the approximate location of the point to be positioned 101, which are computed using a method called code positioning through the GPS observation by the mobile station 1 from the mobile station 1. The positioning server apparatus 30 also receives values observed by the plurality of fixed reference stations 2a, 2b, and 2c, and produces a virtual reference station and virtual observation data according to the above-mentioned VRS method or produces flat correction parameters according to the FKP method. The positioning server apparatus 30 further creates the transformation parameters and the graphic region as shown in FIG. 5, and transmits them to the mobile station 1.

The code positioning is a method of positioning the point to be positioned based on the length of time required for a signal called a code signal, which is carried by an electric wave from each of the GPS satellites 5, to travel from each of the GPS satellites 5 to the mobile station 1. The distance between the mobile station 1 and each of the GPS satellites 5 is computed from the above-mentioned length of time and the location of the point to be positioned 101 is computed according to the requirements of the distance between the mobile station 1 and each of the GPS satellites 5. Usually, the computed location of the point to be positioned 101 has an error of about several to several tens of meters. On the other hand, either of the VRS method and the FKP method is a method of carrying out so-called interferometric positioning in real time according to the difference in phase among the electric waves from the plurality of GPS satellites 5. According to either of the VRS method and the FKP method, the positioning of the point to be positioned 101 can be carried out with a high degree of precision. The electric waves from the GPS satellites 5 are observed at each of two points, and a baseline vector extending from a known reference point, such as a fixed reference point 102, to the point to be positioned 101 is computed from the difference in phase between the electric waves from the GPS satellites 5 which are observed at one of the two points and those observed at the other one of the two points, for example.

According to the VRS method, it is assumed that a virtual reference point is defined, as the known reference point, at a location obtained through the code positioning or in the vicinity of the location, observation data at the virtual reference point are estimated from both the coordinates in the world geodetic system of the plurality of fixed reference stations 2a, 2b, and 2c and current observation data, and the positioning of the point to be positioned 101 is carried out from the estimated observation data and the observation data obtained by the mobile station 1. If the coordinates of the virtual reference point are close to the true coordinates of the point to be positioned 101 and the observation data at the virtual reference point can be estimated appropriately, adverse effects, such as ionosphere delays, are canceled out and the coordinates of the point to be positioned 101 can be computed with a high degree of precision.

According to the FKP method, the amount of correction for the observation data obtained by the mobile station 1 is computed from the observed values observed by the plurality of fixed reference stations 2a, 2b, and 2c, such as the observed phases of carriers, a flat correction parameter which approximates the amount of correction with a plane is created, and this flat correction parameter is then transmitted to the mobile station 1. The mobile station 1 computes the amount of correction for the approximate location from the flat correction parameter transmitted thereto, and also computes the accurate location of the point to be positioned 101 by performing interferometric positioning after correcting the observed values (i.e., the observation data) using the amount of correction. Since the approximate location is sufficiently close to the true location, the approximate location can be used for the calculation of the amount of correction.

The positioning server apparatus 30 creates the transformation parameters and the graphic region used for transforming the observed coordinates in the world geodetic system of the point to be positioned into the coordinates in the existing geodetic system, as well as the correction data, and delivers them to the mobile station 1. For example, this transformation is carried out as follows. The positioning server apparatus 30 receives the coordinates of the approximate location observed at the point to be positioned 101 shown in FIG. 4, and selects, as the graphic region 201, a triangular region having fixed reference points 102, as vertices thereof, and including the approximate location. For the three fixed reference stations 2a, 2b, and 2c, the coordinates in the world geodetic system of the fixed reference points 102a, 102b, and 102c are acquired as well as the coordinates in the existing geodetic system of the fixed reference points 102a, 102b, and 102c. The coordinates in the existing geodetic system of the i-th fixed reference point 102 are represented by Ri(Xi, Yi, Zi), and the coordinates in the world geodetic system of the i-th fixed reference point 102 are represented by ri(xi, yi, zi).

Then, based on the graphic region 201 which consists of the three fixed reference points, the transformation of the coordinates in the world geodetic system of the point to be positioned into the coordinates in the existing geodetic system is carried out. Assume that the graphic region 201 which consists of the a-th, b-th, and c-th fixed reference points 102a, 102b, and 102c is selected. These fixed reference points 102a, 102b, and 102c have coordinates ra (xa, ya, za), rb (xb, yb, zb), and rc(xc, yc, zc), respectively. At this time, when e1=rb−ra, e2=rc−ra, and e3=e1×e2, the coordinates p(x, y, z) in the world geodetic system of the point to be positioned 101 are given by the following equation (1):
p=ra+k1e1+k2e2+de3/||e3|| (1)
where k1 and k2 are variables and the following relationships: 0<=k1<=1, 0<=k2<=1, and 0<=k1+k2<=1 are established, and k1 and k2 are given by the following equation (2):

$$k 1 = \frac{( {p}^{′} \cdot e 1 ) {‖ e 2 ‖}^{2} - ( {p}^{′} \cdot e 2 ) ( e 1 \cdot e 2 )}{{‖ e 1 ‖}^{2} {‖ e 2 ‖}^{2} - {( e 1 \cdot e 2 )}^{2}} \\ k 2 = \frac{( {p}^{′} \cdot e 2 ) {‖ e 1 ‖}^{2} - ( {p}^{′} \cdot e 1 ) ( e 1 \cdot e 2 )}{{‖ e 1 ‖}^{2} {‖ e 2 ‖}^{2} - {( e 1 \cdot e 2 )}^{2}} \\ {p}^{′} = p - d \frac{e 3}{‖ e 3 ‖} \qquad ( 2 )$$

where d is the distance between the coordinates p in the world geodetic system of the point to be positioned 101 and a plane in which the graphic region 201 is placed, and the following relationship: d=(p−ra)e3/″e3|| is established. By using this relationship and assuming that E1=Rb−Ra, E2=Rc−Ra, and E3=E1×E2, for example, an end 111 in the graphic region 201 of a line vertically extending from the point to be positioned having the coordinates p to the graphic region 201 is computed using linear interpolation, and the coordinates P in the existing geodetic system of a point 113 which is distant from the graphic region 202 by only the distance d, as shown in the following equation (3). As an alternative, the end 111 of the line vertically extending from the point to be positioned having the coordinates p to the graphic region 201 is computed by using the interpolation method disclosed by above-mentioned patent reference 1.
P=Ra+k1E1+k2E2+dE3/||E3|| (3)
In this case, the transformation parameters which are needed for the transformation are the coordinates ri(xi, yi, zi) of the i-th fixed reference points 102a, 102b, and 102c, i=a, b, and c, in the world geodetic system, and the coordinates Ri (Xi, Yi, Zi) of the i-th fixed reference points 102a, 102b, and 102c, i=a, b, and c, in the existing geodetic system.

The graphic region 201 is a region in which this transformation can be carried out. Since the above-mentioned transformation is defined by the plurality of fixed reference points 102 which are the vertices of the graphic region 201, it can be applied to the point to be positioned 101 which is located in the interior of this graphic region 201. Therefore, the region in which the transformation can be carried out is this graphic region 201. In order to define this graphic region 201, the coordinates (xi, yi, zi) in the world geodetic system need to be provided for each of the fixed reference points 102a, 102b, and 102c which are the vertices of the graphic region 201. However, since the coordinates (xi, yi, zi) in the world geodetic system are also used as the transformation parameters, further transmission of those coordinates to the mobile station can be omitted.

In the mobile station 1, the GPS antenna 14 and the GPS receiving unit 15 receive the electric waves from the GPS satellites 5, the GPS positioning unit 16 computes the coordinates p0 of the approximate location of the point to be positioned, and the communications unit 13 transmits the coordinates p0 of the approximate location shown in FIG. 4 to the positioning server apparatus 30. The GPS positioning unit 16 carries out interferometric positioning using the correction data from the data delivery station 3 so as to compute the coordinates p in the world geodetic system of the point to be positioned 101. The transformation unit 12 checks to see whether or not the coordinates p in the world geodetic system of the point to be positioned 101 are located in the interior of the graphic region 201, and, if so, transforms the coordinates p into the coordinates P in the existing geodetic system of the point to be positioned 101 by using the transformation parameters. In contrast, when determining that the coordinates p in the world geodetic system of the point to be positioned 101 are located in the exterior of the graphic region 201 which is a triangle, the mobile station 1 transmits the coordinates p in the world geodetic system of the point to be positioned to the positioning server apparatus 30 and then receives a graphic region 201 including the coordinates p in the world geodetic system of the point to be positioned 101 and transformation parameters again from the positioning server apparatus 30.

Since the mobile station is so constructed, even when continuously moving and positioning the point to be positioned 101, for example, the mobile station can acquire the coordinates P in the existing geodetic system of the point to be positioned 101 by performing the above-mentioned transformation on the coordinates p in the world geodetic system of the point to be positioned 101, which is newly computed, without newly receiving transformation parameters from the positioning server apparatus 30. In accordance with the VRS method, since the mobile station performs appropriate transformation on the point to be positioned 101 even when the virtual reference point is distant from the point to be positioned 101, the mobile station can acquire the coordinates in the existing geodetic system of the point to be positioned 101 with a sufficient degree of accuracy. With this structure, the mobile station can determine the location of the point to be positioned 101 with the coordinates in the existing geodetic system of the point.

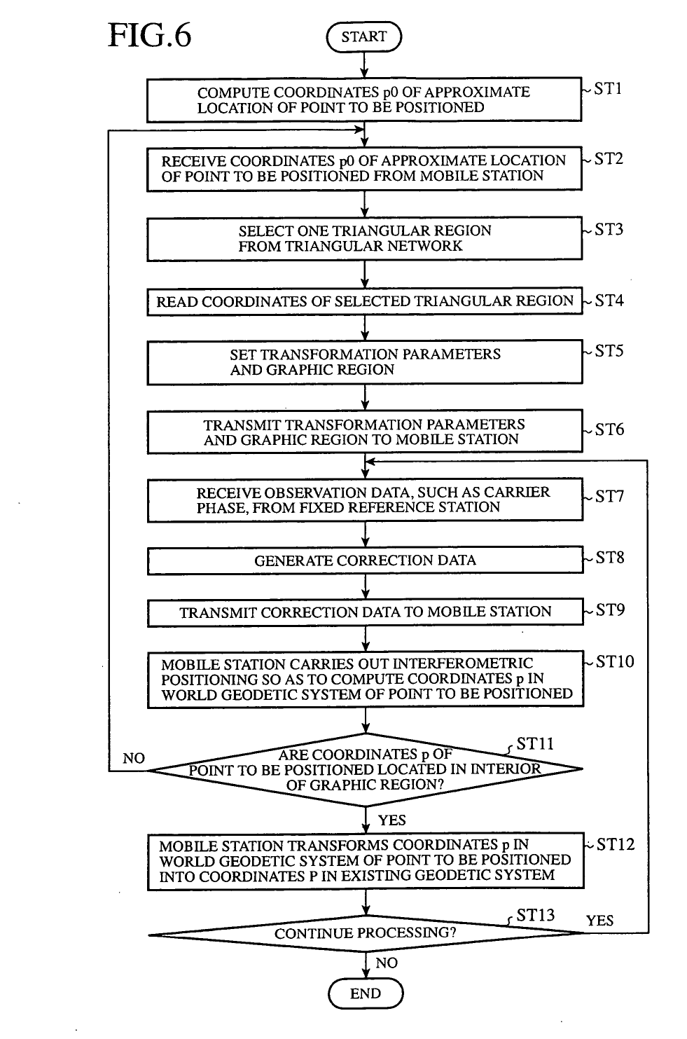

Next, the operation of the positioning system in accordance with this embodiment of the present invention will be explained. FIG. 6 is a flow chart showing a flow of processing carried out by the positioning system in accordance with embodiment 1 of the present invention. In step ST1, the GPS receiving unit 15 of the mobile station 1 performs code positioning on code signals included in the electric waves from the GPS satellites 5. The GPS positioning unit 16 computes the coordinates p0 of an approximate location of the point to be positioned 101, and the communications unit 13 then transmits the computed coordinates p0 of the approximate location of the point to be positioned 101, as shown in FIG. 4, to the positioning server apparatus 30 disposed in the data delivery station via the communications network 100.

In step ST2, the communications unit 35 of the positioning server apparatus 30 receives the coordinates p0 of the approximate location of the point to be positioned 101 transmitted from the mobile station 1. For the first time around, the communications unit 35 of the positioning server apparatus 30 receives the coordinates p0 of the approximate location of the point to be positioned 101. On the other hand, when the processing returns from step ST11, the communications unit 35 of the positioning server apparatus 30 receives the coordinates p in the world geodetic system of the point to be positioned 101. Hereafter, the following steps up to step ST9 are carried out by the positioning server apparatus 30.

In step ST3, the graphic region setting unit 33 selects one triangular region containing the point to be positioned 101 in the interior thereof from the triangular network constituted by plural fixed reference points 102 which is created beforehand and stored in the storage unit 31. In step ST4, the transformation parameter setting unit 32 reads the coordinates in the world geodetic system and those in the existing geodetic system of fixed reference points 102 which are the vertices of the selected triangular region and which are stored in the storage unit 31. The positioning server apparatus 30 updates the coordinates in the world geodetic system of each fixed reference point 102 at any time based on observation data from a corresponding fixed reference station 2, and stores them in the storage unit 31.

In step ST5, the graphic region setting unit 33 of the positioning server apparatus 30 defines the triangular region selected in above-mentioned step ST3 as a graphic region 201 just as it is, and the transformation parameter setting unit 32 of the positioning server apparatus 30 defines the coordinates in the world geodetic system and those in the existing geodetic system of the fixed reference points 102 read in above-mentioned step ST4 as transformation parameters just as they are.

In step ST6, the communications unit 35 of the positioning server apparatus 30 transmits the graphic region 201 and the transformation parameters which are defined in above-mentioned step ST5 and are shown in FIG. 5 to the mobile station 1. In FIG. 5, since the graphic region 201 overlaps a part of the transformation parameters, the transmission of the graphic region 201 can be omitted. Although the graphic region 201 and the transformation parameter are expressed as a series of data, they can be constructed independently.

In step ST7, the communications unit 35 of the positioning server apparatus 30 receives observation data, such as the phases of carriers, which are obtained for the fixed reference points 102a, 102b, and 102c, from the fixed reference stations 2a, 2b, and 2c. These carrier phases indicate the phases of the electric waves which arrive at the GPS receiving units 22 of the fixed reference stations 2a, 2b, and 2c, respectively. Since the distance to each of the GPS satellites 5 differs from point to point, a difference occurs in the phases of the electric waves which arrive at the fixed reference stations 2a, 2b, and 2c at the same time.

In step ST8, the correction data generation unit 34 of the positioning server apparatus 30 generates correction data required for the mobile station 1 to perform interferometric positioning on the point to be positioned 101. At this time, according to the VRS method, an arbitrary point is defined as the virtual reference point during the process of positioning the point to be positioned. For example, the coordinates p0 of the approximate location of the point are defined as the virtual reference point, a carrier phase at the virtual reference point is generated by interpolation from the carrier phases at at least the three fixed reference points 102a, 102b, and 102c received in above-mentioned step ST7, and the virtual reference point and the carrier phases are defined as the correction data. On the other hand, according to the FKP method, the carrier phases at at least the three fixed reference points 102a, 102b, and 102c received in above-mentioned step ST7 are used, a carrier phase in a region surrounded by those fixed reference points 102a, 102b, and 102c is approximated with a plane, for example, a flat correction parameter for this plane is generated as the correction data.

In step ST9, the communications unit 35 of the positioning server apparatus 30 transmits the correction data generated in above-mentioned step ST8 to the mobile station 1. That is, according to the VRS method, the communications unit 35 of the positioning server apparatus 30 transmits the correction data which are the virtual reference point and the carrier phase at the virtual reference point to the mobile station 1. According to the FKP method, the communications unit 35 of the positioning server apparatus 30 transmits the correction data which are the flat correction parameter to the mobile station 1.

In step ST10, the GPS positioning unit 16 of the mobile station 1 performs interferometric positioning on the point to be positioned 101 using the correction data transmitted to the mobile station, and then computes the coordinates p in the world geodetic system of the point to be positioned 101. The mobile station 1 then carries out the following processing.

In step ST11, the transformation unit 12 of the mobile station 1 determines whether or not the coordinates p in the world geodetic system of the point to be positioned, which is computed in above-mentioned step ST10, are located in the interior of the graphic region 201 which is a triangular region and which is transmitted to the mobile station in above-mentioned step ST6. In this case, the transformation unit 12 of the mobile station 1 determines whether the above-mentioned variables k1 and k2 satisfy the following conditions: 0<=k1<=1, 0<=k2<=1, and 0<=k1+k2 <=1, for example. When the transformation unit 12, in above-mentioned step ST11, determines that the coordinates p in the world geodetic system of the point to be positioned are located in the exterior of the graphic region 201, the communications unit 13 of the mobile station 1 transmits the coordinates p in the world geodetic system of the point to be positioned, which is computed in above-mentioned step ST10, to the positioning server apparatus 30, the positioning server apparatus 30 then returns to the process of above-mentioned step ST2 and performs the processes of steps ST2 and the later steps.

In contrast, when the transformation unit 12, in above-mentioned step ST11, determines that the coordinates p in the world geodetic system of the point to be positioned are located in the interior of the graphic region 201 which is a triangular region, the transformation unit 12 of the mobile station 1, in step ST12, transforms the coordinates p in the world geodetic system of the point to be positioned into the coordinates P in the existing geodetic system of the point to be positioned according to above-mentioned equation (3), using the transformation parameters transmitted to the mobile station 1 in above-mentioned step ST6.

The mobile station then, in step ST13, determines whether to perform the processing succeedingly. For example, the mobile station determines whether to perform the processing succeedingly by determining whether or not an input indicating completion of the processing has been applied to the GPS positioning unit 16. When performing the processing succeedingly, the positioning system returns to step ST7 in which it repeats the positioning processing. Even when the point to be positioned 101 of the mobile station 1 moves, since the transformation unit 12 of the mobile station 1 can transform the coordinates p in the world geodetic system of the point to be positioned 101 into the coordinates P in the existing geodetic system of the point to be positioned 101 using the same transformation parameters as long as the point to be positioned 101 is located in the interior of the graphic region 201, further transmission of the transformation parameters and the graphic region 201 becomes unnecessary.

As mentioned above, in accordance with the present invention, as long as the coordinates in the world geodetic system of the point to be positioned 101, which are computed by the GPS positioning unit 16 of the mobile station 1 are located in the interior of the graphic region 201 set by the graphic region setting unit 33 of the positioning server apparatus 30, the conversion unit 12 of the mobile station 1 transforms the coordinates in the world geodetic system of the point to be positioned 101 into the coordinates in the existing geodetic system using the transformation parameters set by the transformation parameter setting unit 32 of the positioning server apparatus 30. Therefore, the mobile station can use the same transformation parameters for positioning of two or more points to be positioned 101, and can compute the location of any point to be positioned 101 with the coordinates in the existing geodetic system of the point with a high degree of precision, without increasing the amount of traffic in the communications network 100.

In addition, in accordance with this embodiment 1, the transformation parameter setting unit 32 of the positioning server apparatus 30 sets transformation parameters used for performing linear interpolation on the difference between the coordinates in the existing geodetic system and the coordinates in the world geodetic system, and the conversion unit 12 of the mobile station 1 transforms the coordinates in the world geodetic system of the point to be positioned 101 into the coordinates in the existing geodetic system using the transformation parameters used for carrying out linear interpolation. Therefore, the mobile station can easily compute the location of the point to be positioned 101.

Furthermore, in accordance with this embodiment 1, the graphic region setting unit 33 of the positioning server apparatus 30 sets a triangular region as the graphic region 201, and the GPS positioning unit 16 of the mobile station 1 determines whether or not the coordinates in the world geodetic system of the point to be positioned 101 are located in the interior of the triangular region set by the graphic region setting unit 33. Therefore, the mobile station 1 can easily determine whether the transformation unit 12 thereof can apply the transformation parameters to the transformation of the coordinates in the world geodetic system of the point to be positioned 101 into the coordinates in the existing geodetic system.

### Embodiment 2

A positioning system in accordance with embodiment 2 of the present invention has the same structure as that in accordance with above-mentioned embodiment 1 shown in FIG. 1. Basically, the positioning system in accordance with embodiment 2 of the present invention carries out processing according to the flow chart of FIG. 6 showing the flow of the processing carried out by that in accordance with above-mentioned embodiment 1.

In accordance with above-mentioned embodiment 1, the positioning system is so constructed as to carry out transformation of the coordinates in the world geodetic system of a point to be positioned into the coordinates in the existing geodetic system of the point in three dimensions. In contrast, the positioning system of this embodiment 2 is so constructed as to carry out planar transformation of the coordinates in the world geodetic system of the point to be positioned into the coordinates in the existing geodetic system in a horizontal plane. When a difference between the coordinates in the world geodetic system of the point to be positioned and the coordinates in the existing geodetic system of the point occurs due to crustal movements, the difference is of the order of ppm with respect to the baseline vector. Usually, the baseline vector has a small component in a vertical direction, and it is therefore difficult to realize the difference in view of errors in the GPS positioning. For this reason, the transformation of the coordinates in the world geodetic system of the point to be positioned into the coordinates in the existing geodetic system of the point has only to be carried out with two-dimensional correction in a horizontal plane.

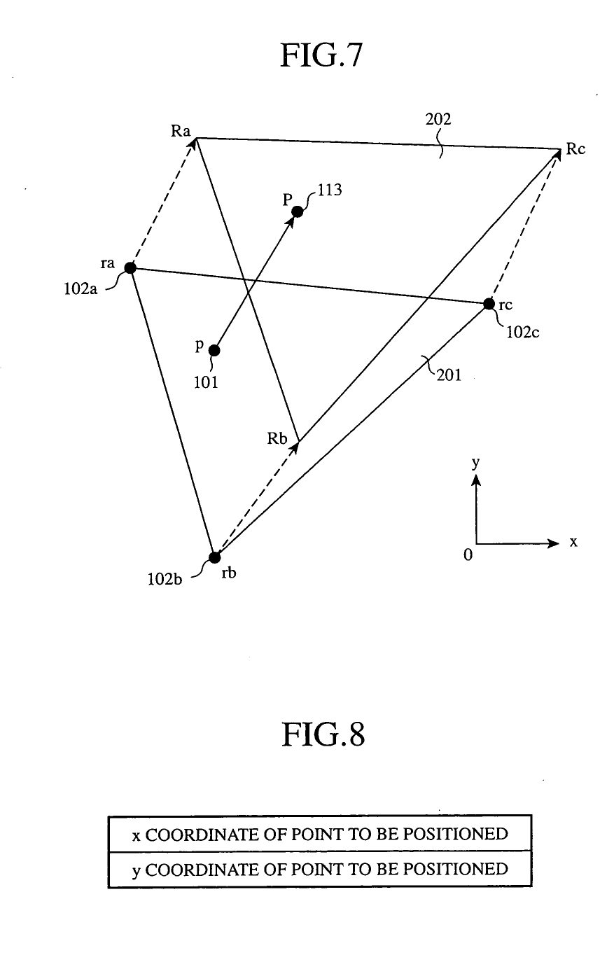

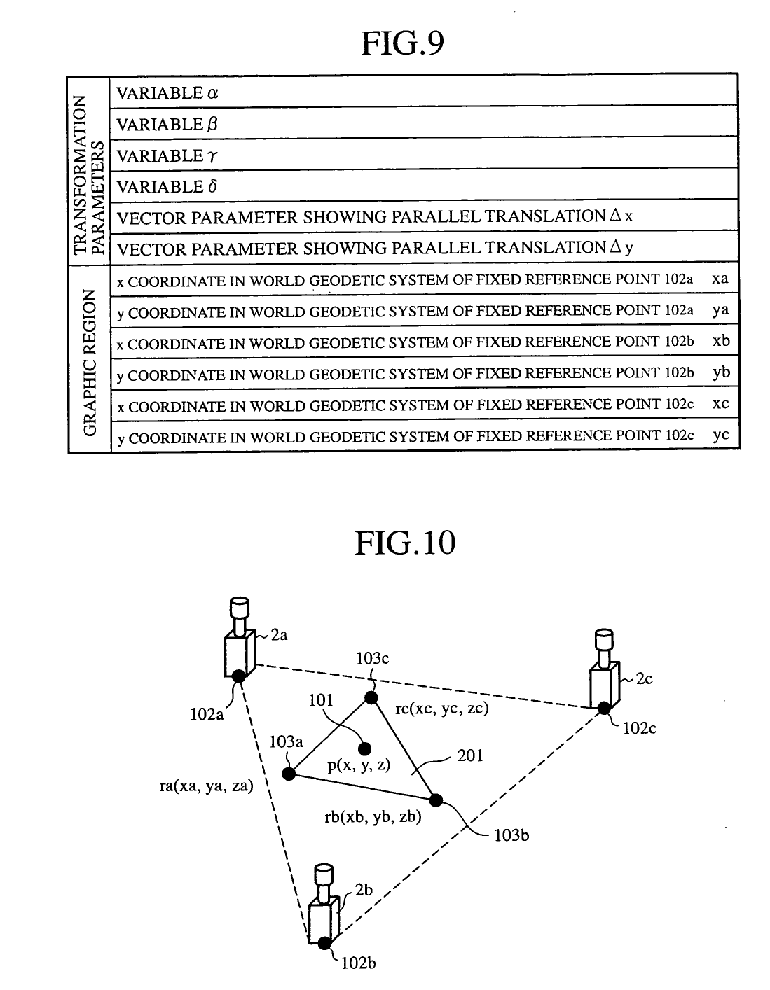

FIG. 7 is a diagram explaining the two-dimensional transformation of the coordinates in the world geodetic system of the point to be positioned 101 of the mobile station 1 into the coordinates in the existing geodetic system of the point. FIG. 8 is a diagram showing the two-dimensional coordinates of an approximate location of the point to be positioned 101 which the mobile station 1 transmits to a positioning server apparatus 30, and FIG. 9 is a diagram showing transformation parameters and a graphic region which the positioning server apparatus 30 transmits to the mobile station 1. In this case, for either of the world geodetic system and the existing geodetic system, the coordinates are expressed by a set of latitude, longitude, and ellipsoid height, or defined in a UTM (Universal Transverse Mercator projection) coordinates system or a plane Cartesian-coordinates system. A case where the coordinates are defined in a plane Cartesian-coordinates system in which the xy axis is located in a horizontal plane will be explained as an example. Although the Japan-19 Plane Orthogonal is set so that the x-axis is directed to the north and the y-axis is directed to the east, the two-dimensional transformation will be explained hereafter assuming that the x axis of the plane Cartesian-coordinates system is directed to the right of FIG. 7 and the y axis is directed to an upper side of FIG. 7. Another plane Cartesian-coordinates system or another coordinates system can be provided by replacing those axes with other axes.

In this case, the transformation parameters can be coordinates in the world geodetic system, and transformation for superimposing a triangular region planarly expressed by x and y coordinates of the plane Cartesian-coordinates system on a triangular region expressed by coordinates in the existing geodetic system with scaling, or rotation and shearing, i.e., affine transformation, can be used. The mobile station carries out the affine transformation of the coordinates of the point to be positioned 101, which are computed in the world geodetic system, into the coordinates in the existing geodetic system of the point so as to acquire the coordinates of the location of the point to be positioned which conform to the determined coordinates of objects in the vicinity of the point to be positioned. The outline of this affine transformation is shown in FIG. 7. A graphic region 201 which is a triangular region is transformed into a graphic region 202 which is similarly a triangular region. When the coordinates in the existing geodetic system of the point to be positioned are P(X, Y) and the coordinates in the world geodetic system of the point to be positioned are p(x, y), this affine transformation is expressed by the following equation (4):
X=αx+βy+Δx
Y=γx+δy+Δy (4)
where α, β, γ, δ are variables and (Δx, Δy) is a vector showing parallel translation. The affine transformation expressed by equation (4) is carried out, in step ST12 of FIG. 6, by a transformation unit 12 of the mobile station 1.

When the coordinates (xi, yi), i=a, b, and c, in the world geodetic system are transformed into the coordinates (Xi, Yi), i=a, b, and c, in the existing geodetic system for three fixed reference points 102a, 102b, and 102c, respectively, a transformation parameter setting unit 32 of the positioning server apparatus 30 establishes six simultaneous equations given by the following equation (5), and solves these simultaneous equations so as to acquires six unknowns: α, β, γ, δ, Δx, and Δy.
Xi=αxi+βyi+Δx
Yi=γxi+δyi+Δy, i=a, b, c (5)

Next, the operation of the positioning system in accordance with this embodiment of the present invention will be explained. The positioning server apparatus 30, in step ST2 of FIG. 6, receives the coordinates p0, as shown in FIG. 8, of a two-dimensional approximate location of the point to be positioned 101 from the mobile station 1, and a graphic region setting unit 33 of the positioning server apparatus 30, in step ST5 of FIG. 6, defines the coordinates in the world geodetic system of the three fixed reference points 102a, 102b, and 102c in the triangular region specified by (xi, yi) i=a, b, and c, as a graphic region 201. The transformation parameter setting unit 32 of the positioning server apparatus 30 then solves the simultaneous equations given by above-mentioned equation (5) so as to acquire the variables α, β, γ, δ and the vector (Δx, Δy) showing parallel translation, and defines the variables and the vector as transformation parameters. A communications unit 35 of the positioning server apparatus 30 then, in step ST6 of FIG. 6, transmits the transformation parameters and the graphic region 201 which are set in above-mentioned step ST5 and which are shown in FIG. 9 to the mobile station 1.

The transformation unit 12 of the mobile station 1 then, in step ST12 of FIG. 6, performs the affine transformation expressed by above-mentioned equation (4) on the determined coordinates p(x, y) in the world geodetic system of the point to be positioned 101 using the transformation parameters transmitted to the mobile station from the positioning server apparatus 30, so as to transform the coordinates in the world geodetic system of the point to be positioned 101 into the coordinates in the existing geodetic system of the point to be positioned 101, as shown in FIG. 7. The height of the point is not changed. The positioning system in accordance with this embodiment 2 operates in the same way that the positioning system in accordance with embodiment 1 does, except when the mobile station 1 carries out the two-dimensional transformation.

As mentioned above, in accordance with this embodiment 2 of the present invention, as long as the coordinates in the world geodetic system of the point to be positioned 101, which are computed by the GPS positioning unit 16 of the mobile station 1, are located in the interior of the graphic region 201 set by the graphic region setting unit 33 of the positioning server apparatus 30, the transformation unit 12 of the mobile station 1 transforms the coordinates in the world geodetic system of the point to be positioned 101 into the coordinates in the existing geodetic system of the point using the transformation parameters set by the transformation parameter setting unit 32 of the positioning server apparatus 30. Therefore, the positioning system of this embodiment 2 can use the same transformation parameters for two or more points to be positioned 101, and can compute the location of any point to be positioned 101 with the coordinates in the existing geodetic system of the point, with a high degree of precision and without increasing the amount of traffic in the communications network 100.

In addition, in accordance with this embodiment 2, the transformation parameter setting unit 32 of the positioning server apparatus 30 sets the transformation parameters used for carrying out the two-dimensional affine transformation, and the transformation unit 12 of the mobile station 1 carries out the affine transformation of the coordinates in the world geodetic system of the point to be positioned 101 to the coordinates in the existing geodetic system of the point using the transformation parameters set by the transformation parameter setting unit 32. Therefore, the positioning system can easily compute the location of the point to be positioned 101 of the mobile station, and can reduce the amount of data to be delivered without large degradation in the accuracy of the transformation and can perform the transformation with simple arithmetic operations by using the transformation parameters used for carrying out the two-dimensional affine transformation.

Furthermore, in accordance with this embodiment 2, the graphic region setting unit 33 of the positioning server apparatus 30 defines a triangular region as the graphic region 201, and the GPS positioning unit 16 of the mobile station 1 determines whether or not the coordinates in the world geodetic system of the point to be positioned 101 are located in the interior of the triangular region. Therefore, the mobile station 1 can easily determine whether the transformation unit 12 thereof can apply the transformation parameters to the two-dimensional affine transformation.

### Embodiment 3

A positioning system in accordance with embodiment 3 of the present invention has the same structure as that in accordance with above-mentioned embodiment 1 shown in FIG. 1. The positioning system in accordance with either of above-mentioned embodiments 1 and 2 sets the transformation parameters and the graphic region 201 from both the coordinates in the world geodetic system of the fixed reference points 102 of fixed reference stations 2 and the coordinates in the existing geodetic system of the fixed reference points 102. However, taking the fact that crustal movements don't occur rapidly into consideration, it is not necessary to necessarily acquire both the coordinates in the world geodetic system of those fixed reference points 102 and the coordinates in the existing geodetic system of the fixed reference points 102 in real time. Therefore, the positioning system of this embodiment is so constructed as to use both the coordinates in the world geodetic system of fixed reference points 102 and the coordinates in the existing geodetic system of the fixed reference points 102 which it has acquired beforehand.

FIG. 10 is a diagram for explaining setting of a graphic region by the positioning system in accordance with embodiment 3 of the present invention. The positioning system uses reference points 103, as well as fixed reference points 102, when setting the transformation parameters and the graphic region 201. For an area where the difference between the coordinates in the world geodetic system and the coordinates in the existing geodetic system is large and complicated, it is difficult to approximate the difference using the transformation parameters about only fixed reference points 102 where GPS observation is being carried out. A fine triangular network is formed so as to include reference points 103 whose coordinates in the existing geodetic system and recently-observed coordinates in the world geodetic system are known, in addition to fixed reference points 102.

Reference points 103 correspond to the vertices of a triangular region, respectively, and the coordinates of the reference points 103 are stored in a storage unit 31 of a positioning server apparatus 30. Instead of both the coordinates in the existing geodetic system and the coordinates in the world geodetic system, or the latter coordinates, the epoch of the existing positioning system and a velocity vector indicating a change per year of the coordinates in the existing geodetic system can be stored as the coordinates of each reference point 103. In this case, the same advantages can be expected to be provided using the coordinates in the existing geodetic system+the velocity vector×(time-epoch) without always positioning the newest coordinates in the world geodetic system.

A transformation triangular network used for the transformation is formed so as to include both fixed reference points 102 and reference points 103, and is stored in the storage unit 31 of the positioning server apparatus 30. That is, the transformation triangular network is formed so that a union including points which are fixed reference points 102 and other points which are reference points 103 is defined and a target whole region is divided by a plurality of triangular regions whose vertices are points included in the union. For example, triangular regions each of which has only fixed reference points 102 as the vertices thereof, triangular regions each of which has only reference points 103 as the vertices thereof, and triangular regions each of which has one or more fixed reference points 102 and one or more reference points 103 as the vertices thereof exist in the transformation triangular network.

The coordinates in the world geodetic system are provided for each fixed reference point 102, and either the coordinates in the world geodetic system or the coordinates in the world geodetic system which are corrected using a velocity vector are provided for each reference point 103. For example, Delaunay triangulation is performed on the target whole region using the coordinates in the world geodetic systems of points including fixed reference points 102 and reference points 103 so as to create the transformation triangular network. The Delaunay triangulation is carried out in a two-dimensional plane, such as a plane specified by the latitude and longitude coordinates of location coordinates, or an xy plane defined on a horizontal surface, such as a plane Cartesian-coordinates system.

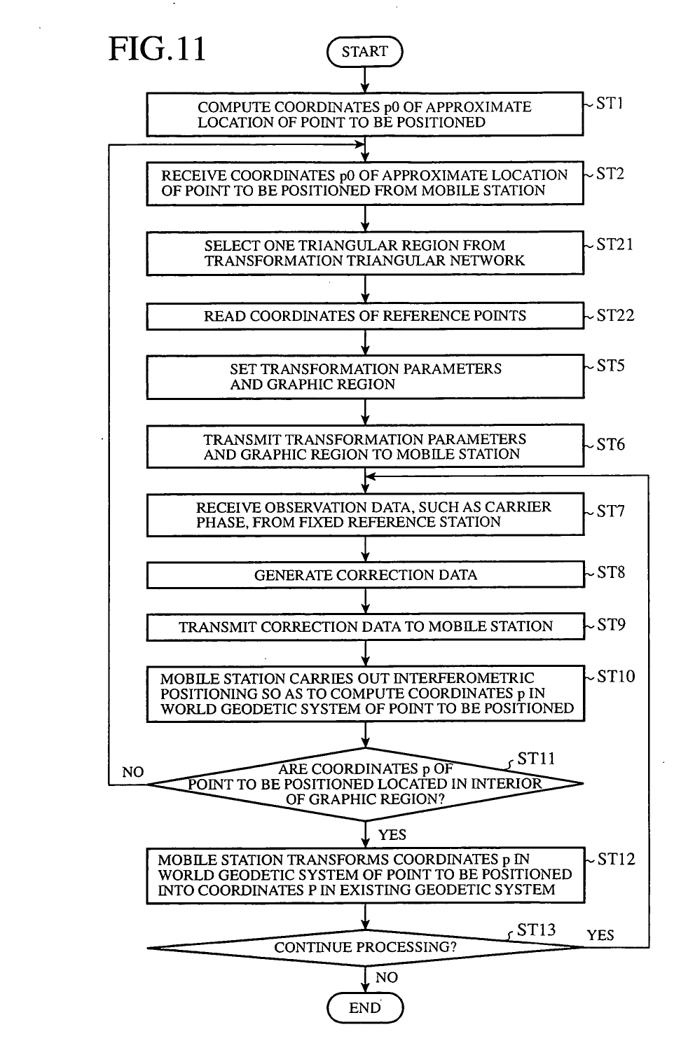

Next, the operation of the positioning system in accordance with this embodiment of the present invention will be explained. FIG. 11 is a flow chart showing a flow of processing carried out by the positioning system in accordance with embodiment 3 of the present invention. The explanation of the same steps as shown in FIG. 6 of embodiment 1 will be omitted hereafter. A graphic region setting unit 33 of the positioning server apparatus 30, in step ST21, selects one triangular region from the transformation triangular network which is created beforehand. This selected triangular region is the one including the coordinates p0 of an approximate location of a point to be positioned 101 of a mobile station. The graphic region setting unit 33, in step ST5, defines this triangular region as a graphic region 201. In the example shown in FIG. 10, this triangular region consists of three reference points 103. Although a correction data generation unit 34 uses fixed reference stations 2 in order to generate correction data, those reference points 103 are selected independently from the fixed reference stations 2 used for generation of the correction data.

A transformation parameter setting unit 32, in step ST22, reads the coordinates in the existing geodetic system and coordinates in the world geodetic system of the three reference points 103 of the triangular region which is defined as the graphic region 201 from the storage unit 31. Assume that the a-th, b-th, and c-th reference points 103a, 103b, and 103c are selected, and the coordinates in the world geodetic system of these points are ra (xa, ya, za), rb (xb, yb, zb), and rc (xc, yc, zc), respectively, and the coordinates in the existing geodetic system of the points are Ra(Xa, Ya, Za), Rb(Xb, Yb, Zb), and Rc(Xc, Yc, Zc), respectively. The positioning system in accordance with this embodiment 3 operates in the same way that the positioning system in accordance with either of above-mentioned embodiments 1 and 2 does, except when the positioning server apparatus 30 sets the transformation parameters and the graphic region.

In the case of this embodiment 3, instead of the coordinates in the world geodetic system and coordinates in the existing geodetic system of fixed reference points 102a, 102b, and 102c which are shown in FIG. 5 of embodiment 1 and FIG. 9 of embodiment 2, the positioning server apparatus 30 transmits, as the transformation parameters and the graphic region 201, the coordinates in the world geodetic system and coordinates in the existing geodetic system of the three reference points 103a, 103b, and 103c to the mobile station 1.

As mentioned above, in accordance with this embodiment 3 of the present invention, as long as the coordinates in the world geodetic system of the point to be positioned 101, which are computed by the GPS positioning unit 16 of the mobile station 1, are located in the interior of the graphic region 201 set by the graphic region setting unit 33 of the positioning server apparatus 30, the transformation unit 12 of the mobile station 1 transforms the coordinates in the world geodetic system of the point to be positioned 101 into the coordinates in the existing geodetic system of the point using the transformation parameters set by the transformation parameter setting unit 32 of the positioning server apparatus 30. Therefore, the positioning system of this embodiment 3 can use the same transformation parameters for two or more points to be positioned 101, and can compute the location of any point to be positioned 101 with the coordinates in the existing geodetic system of the point, with a high degree of precision and without increasing the amount of traffic in the communications network 100.

In addition, in accordance with this embodiment 3, the positioning server apparatus 30 is so constructed as to set the graphic region 201 with a group of reference points 103 so as to acquire the transformation parameters. Therefore, by arranging reference points 103 densely, even when the difference between the coordinates in the world geodetic system and the coordinates in the existing geodetic system is large and complicated, the positioning server apparatus 30 can set the transformation parameters using the coordinates of reference points 103 in the vicinity of the point to be positioned 101, and the mobile station can acquire the coordinates in the existing geodetic system of the point to be positioned appropriately.

Furthermore, in accordance with this embodiment 3, the coordinate information on the coordinates of all reference points 103 is stored in the storage unit 31 of the positioning server apparatus 30, and the transformation parameters and the graphic region 201 are set by the transformation parameter setting unit 32 and graphic region setting unit 33 of the positioning server apparatus 30. Therefore, since even when a change occurs in the coordinates in the world geodetic system of a reference point 103 due to crustal movements, the change can be reflected throughout the coordinate information stored in the storage unit 31 only by updating a corresponding piece of coordinate information on the reference point 103, the positioning system can collectively mange the coordinate information stored in the storage unit 31 to bring the coordinate information up to date. In addition, the positioning system of this embodiment can prevent the load of the setting of the transformation parameters and the graphic region 201 and the load of maintenance of the coordinate information on reference points 103 on the mobile station 1.

### Embodiment 4

A positioning system in accordance with embodiment 4 of the present invention has the same structure as that in accordance with above-mentioned embodiment 1 shown in FIG. 1. In either of above-mentioned embodiments 1 to 3, the transformation parameters are determined from three fixed reference points 102 or reference points 103 which are the vertices of a triangular region, and the triangular region is defined as the graphic region 201. The method of determining the transformation parameters and the graphic region 201 is not limited to this method.

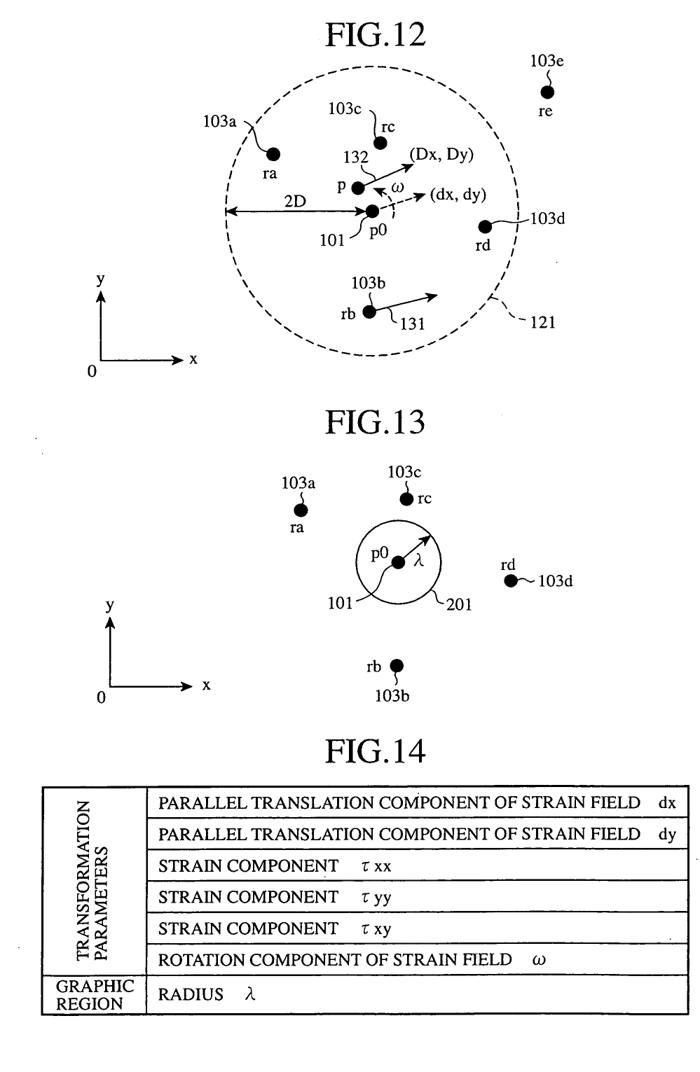

FIG. 12 is a diagram explaining transformation into the coordinates in an existing geodetic system of a point to be positioned 101 of a mobile station 1, and FIG. 13 is a diagram explaining a graphic region. A movement vector 132 at the point to be positioned 101 is acquired from movement vectors 131 which are related with reference points 103 located in the interior of a surrounding area 121 of the point to be positioned 101, each of the movement vectors 131 being directed from the coordinates in the existing geodetic system of the corresponding reference point 103 to the coordinates in the world geodetic system of the corresponding reference point 103. A movement vector has a value which is the subtraction of the corresponding coordinates in the existing geodetic system from the corresponding coordinates in the world geodetic system. The graphic region 201 is a circular region having a radius of A and a center at the point to be positioned 101, as shown in FIG. 13.

The transformation into the coordinates in the existing geodetic system of the point to be positioned 101 of the mobile station 1 will be explained by taking, as an example, a case where the transformation is carried out in a two-dimensional xy plane on a horizontal surface, such as a plane Cartesian-coordinates system. Assume that the change in the direction of height is very small. As a method of estimating the movement vector 132 at the point to be positioned 101 from the movement vectors 131 at reference points 103 including fixed reference points 102 and located in the interior of the surrounding area 121 of the point to be positioned 101, a method disclosed in “Crustal deformation across and beyond the Los Angels basin from geodetic measurements”, by Z. K. Shen, D. D. Jackson, and B. X. germanium, JOURNAL OF GEOPHYSICAL RESEARCH, Vol. 101, No. B12, pp. 27980 to 27957, 1996 is used. According to this method, the movement vector 132 at the point to be positioned 101 is determined from the movement vectors 131 at the reference points 103 located in the interior of the surrounding area 121 of the point to be positioned 101, as shown in FIG. 12. In FIG. 12, reference points 103a, 103b, 103c, and 103d located at a distance of 2D or less from the point to be positioned 101, i.e., located in the interior of the surrounding area 121 having a radius of 2D, are selected, whereas a reference point 103e is not selected. In order to compute the movement vector 132 at the point to be positioned 101, three or more reference points 103 are needed.

Assuming that the amount of strain that occurs in the vicinity of the point to be positioned 101 is uniform, when a parallel translation component of the strain field is shown by (dx, dy), a rotation component of the strain field in the surrounding area 121 of the point to be positioned 101 is shown by ω, and strain components are τxx, τyy and τxy, the movement vector 131 at the i-th reference point 103 is modeled by the following equation (6):

$$( \begin{matrix}xi - Xi \\ yi - Yi\end{matrix} ) = ( \begin{matrix}1 & 0 & xi - x 0 & yi - y 0 & 0 & yi - y 0 \\ 0 & 1 & 0 & xi - x 0 & yi - y 0 & - ( xi - x 0 )\end{matrix} ) ( \begin{matrix}dx \\ dy \\ τ xx \\ τ xy \\ τ yy \\ ω\end{matrix} ) + ( \begin{matrix}ɛ xi \\ ɛ yi\end{matrix} ) \qquad ( 6 )$$

where the coordinates of the point to be positioned 101 are represented by the coordinates p0(x0, y0) of an approximate location of he point to be positioned 101, for convenience' sake. The coordinates of the point to be positioned 101 are also represented by the coordinates p0(x0, y0) when acquiring the transformation parameters again using p. The strain components τxx, τyy, and τxy indicate a vertical strain in the direction of x-axis, a vertical strain in the direction of y-axis, and a shearing strain, respectively.

εxi and εyi are errors for the i-th reference point 103. For example, they are defined by the following equation (7).

$$ɛ xi = σ xi exp \frac{{‖ ri - p 0 ‖}^{2}}{2 {D}^{2}} \\ ɛ yi - σ yi exp \frac{{‖ ri - p 0 ‖}^{2}}{2 {D}^{2}} \qquad ( 7 )$$

The errors increase with distance from the point to be positioned 101. σxi and σyi are standard deviations of observed errors, which are computed based on actual observation results. As an alternative, it can be assumed that the errors are constant. D is a parameter called a distance constant. In order to acquire six transformation parameters which are unknowns, three or more reference points 103 are needed. By assigning weights to the movement vectors 131 at the three or more reference points 103 using εxi and εyi, the weights decreasing from distance from the point of positioned 101, the transformation parameters dx, dy, ω, τxx, τyy, and τxy are determined from the movement vectors 131 using a least-squares method. The parameter D is 35 km, for example. The surrounding area 121 is a range having a distance of 2D from the approximate location p0 of the point to be positioned 101.

The movement vector 132 at the coordinates p(x, y) in the world geodetic system of the point to be positioned 101 obtained through interferometric positioning is acquired using those transformation parameters. When the movement vector 132 is shown by (Dx, Dy) and the coordinates in the existing geodetic system of the point to be positioned 101 are shown by P(X, Y), the coordinates P(X, Y) in the existing geodetic system of the point to be positioned 101 can be computed from the movement vector 132 according to the following equation (8):

$$( \begin{matrix}Dx \\ Dy\end{matrix} ) = ( \begin{matrix}1 & 0 & x - x 0 & y - y 0 & 0 & y - y 0 \\ 0 & 1 & 0 & x - x 0 & y - y 0 & - ( x - x 0 )\end{matrix} ) ( \begin{matrix}dx \\ dy \\ τ xx \\ τ xy \\ τ yy \\ ω\end{matrix} ) \\ ( \begin{matrix}X \\ Y\end{matrix} ) = ( \begin{matrix}x \\ y\end{matrix} ) - ( \begin{matrix}Dx \\ Dy\end{matrix} ) \qquad ( 8 )$$

Even when the coordinates p0 of the approximate location of the point to be positioned 101 used at the beginning have an error and therefore differs from the coordinates p(x, y) in the world geodetic system obtained through interferometric positioning, or even when the point to be positioned 101 is moving, the coordinates P (X, Y) in the existing geodetic system of the point to be positioned 101 can be computed according to above-mentioned equation (8).

The graphic region 201 is determined as follows, for example. When the number of reference points 103 used for the calculation of the movement vector 132 is four or more, the difference between the movement vector 131 at the i-th reference point 103 which is acquired from the above-mentioned transformation parameters and the actual movement vector 131 is computed according to the following equation (9):

$$( \begin{matrix}ɛ xi \\ ɛ yi\end{matrix} ) = ( \begin{matrix}xi - Xi \\ yi - Yi\end{matrix} ) - ( \begin{matrix}1 & 0 & xi - x 0 & yi - y 0 & 0 & yi - y 0 \\ 0 & 1 & 0 & xi - x 0 & yi - y 0 & - ( xi - x 0 )\end{matrix} ) ( \begin{matrix}dx \\ dy \\ τ xx \\ τ xy \\ τ yy \\ ω\end{matrix} ) \qquad ( 9 )$$

As a result, the following equation is obtained:

$$σ xi = ɛ xi exp ( - \frac{{‖ ri - p 0 ‖}^{2}}{2 {D}^{2}} ) \\ σ yi = ɛ yi exp ( - \frac{{‖ ri - p 0 ‖}^{2}}{2 {D}^{2}} ) \qquad ( 10 )$$

A maximum σm of σxi and σyi is obtained from them.

$$σ m exp \frac{{λ}^{2}}{2 {D}^{2}} \leq ɛ max \qquad ( 11 )$$

Then, a distance λ that satisfies the following equation is defined.

$$λ = D \sqrt{2 log \frac{ɛ max}{σ m}} \qquad ( 12 )$$

It can be expected that the error becomes equal to or less than εmax in the interior of a circular region having a center at the coordinates p0 of the approximate location of the point to be positioned 101 and a radius of λ. The graphic region setting unit 33 thus defines the circular region having a center at the coordinates p0 of the approximate location of the point to be positioned 101 and a radius of λ as the graphic region 201, as shown in FIG. 13.

When the number of reference points 103 used for the calculation of the movement vector 132 is three, the graphic region setting unit 33 defines a circular region having a center at the point to be positioned 101 and a radius equal to a minimum of the distances from the center to the three reference points, as the graphic region 201, for example. As an alternative, the graphic region setting unit 33 can define a triangular region whose vertices are three reference points, as the graphic region 201, like that in accordance with either of above-mentioned embodiments 1 to 3.

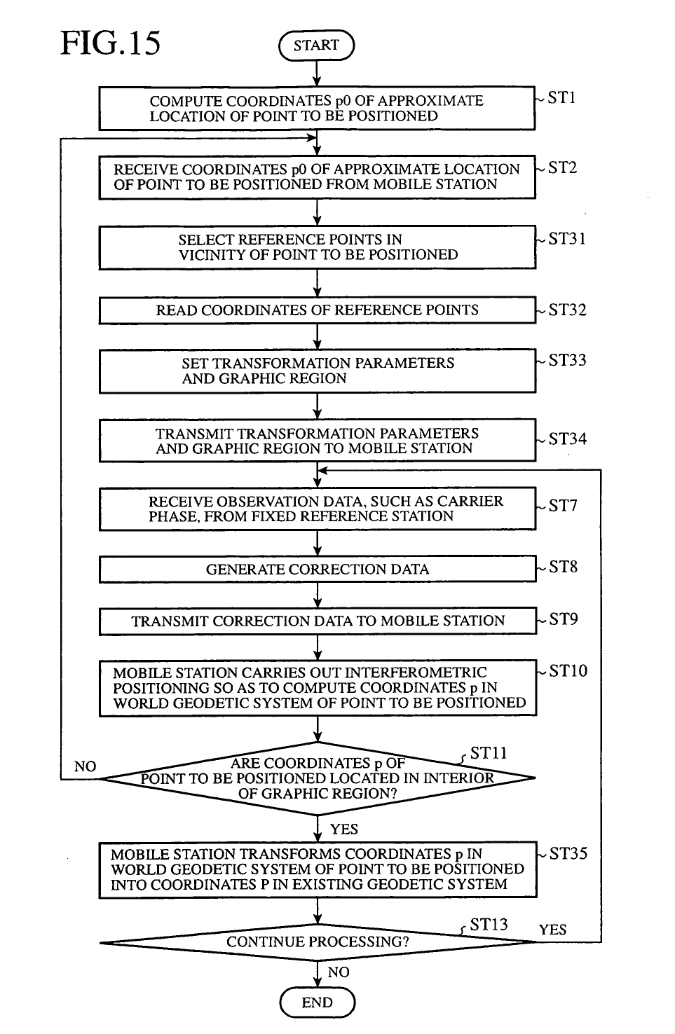

Next, the operation of the positioning system in accordance with this embodiment of the present invention will be explained FIG. 15 is a flow chart showing a flow of processing carried out by the positioning system in accordance with embodiment 4 of the present invention. The explanation of the same steps as shown in FIG. 6 of embodiment 1 will be omitted hereafter. The graphic region setting unit 33 of the positioning server apparatus 30, in step ST31, extracts reference points 103 which are located in the surrounding area 121 in the vicinity of the coordinates of the approximate location of the point to be positioned 101 received from the mobile station 1, and which are stored in the storage unit 31. The transformation parameter setting unit 32 then, in step ST32, reads both the coordinates in the existing geodetic system and the coordinates in the world geodetic system of the extracted reference points 103, which are stored in the storage unit 31.

The transformation parameter setting unit 32 of the positioning server apparatus 30, in step ST33, sets the transformation parameters dx, dy, ω, τxx, τyy and τxy by solving above-mentioned equations (6) and (7), and the graphic region setting unit 33 of the positioning server apparatus 30 sets the graphic region 201 by calculating the radius A using above-mentioned equations (9) to (12). When setting the transformation parameters and the graphic region 201, the positioning server apparatus 30 uses the above-mentioned method disclosed by Z. K. Shen et al. The communications unit 35 of the positioning server apparatus 30 then, in step ST34, delivers the transformation parameters and graphic region 201 set thereby to the mobile station 1.

FIG. 14 is a diagram showing the transformation parameters and the graphic region which the positioning server apparatus 30 transmits to the mobile station 1. For example, when the graphic region 201 is a circular region having a radius λ, the transformation parameters and the graphic region have the form as shown in FIG. 14.

The transformation unit 12 of the mobile station 1, in step ST35, transforms the determined coordinates p(x, y) in the world geodetic system of the point to be positioned 101 into the coordinates in the existing geodetic system using the transformation parameters transmitted from the positioning server apparatus 30 according to above-mentioned equation (8).

As mentioned above, in accordance with this embodiment 4 of the present invention, as long as the coordinates in the world geodetic system of the point to be positioned 101, which are computed by the GPS positioning unit 16 of the mobile station 1, are located in the interior of the graphic region 201 set by the graphic region setting unit 33 of the positioning server apparatus 30, the transformation unit 12 of the mobile station 1 transforms the coordinates in the world geodetic system of the point to be positioned 101 into the coordinates in the existing geodetic system of the point using the transformation parameters set by the transformation parameter setting unit 32 of the positioning server apparatus 30. Therefore, the positioning system of this embodiment 4 can use the same transformation parameters for two or more points to be positioned 101, and can compute the location of any point to be positioned 101 with the coordinates in the existing geodetic system of the point, with a high degree of precision and without increasing the amount of traffic in the communications network 100.

In addition, in accordance with this embodiment 4, the transformation parameter setting unit 32 of the positioning server apparatus 30 defines a rotation component, a strain component, and a parallel translation component of the strain field in the vicinity of the point to be positioned 101 as the transformation parameters, and the transformation unit 12 of the mobile station 1 transforms the coordinates in the world geodetic system of the point to be positioned 101 into the coordinates in the existing geodetic system using the set transformation parameters. Therefore, the mobile station can easily compute the location of the point to be positioned 101. Furthermore, since the coordinates in the world geodetic system and the coordinates in the existing geodetic system of an object in the vicinity of the point to be positioned 101 can be determined using information on three or more known reference points 103, they are resistant to be dependent upon errors of the locations of the reference points 103, and the transformation of the coordinates in the world geodetic system into the coordinates in the existing geodetic system can be carried out with a high degree of precision.

In addition, in accordance with this embodiment 4, the graphic region setting unit 33 of the positioning server apparatus 30 defines a circular region having a center at the coordinates of the approximate location of the point to be positioned 101 and a predetermined radius A as the graphic region 201, and the GPS positioning unit 16 of the mobile station 1 determines whether or not the coordinates in the world geodetic system of the point to be positioned 101 are located in the interior of the set circular region. Therefore, the mobile station 1 can easily determine whether the transformation unit 12 thereof can apply the transformation parameters to the transformation of the coordinates in the world geodetic system of the point to be positioned 101 into the coordinates in the existing geodetic system. Furthermore, the positioning server apparatus 30 has only to transmit the radius λ, as the information on the graphic region 201, to the mobile station by defining the circular region as the graphic region 201. Therefore, the amount of traffic in the communications network 100 can be reduced.

### Embodiment 5

In accordance with either of above-mentioned embodiments 1 to 4, the positioning server apparatus 30 of the data delivery station 3 generates the transformation parameters and the graphic region 201. In contrast, a positioning system in accordance with this embodiment 5 further includes a data generation station that generates the transformation parameters and the graphic region 201, in addition to a data delivery station 3′.

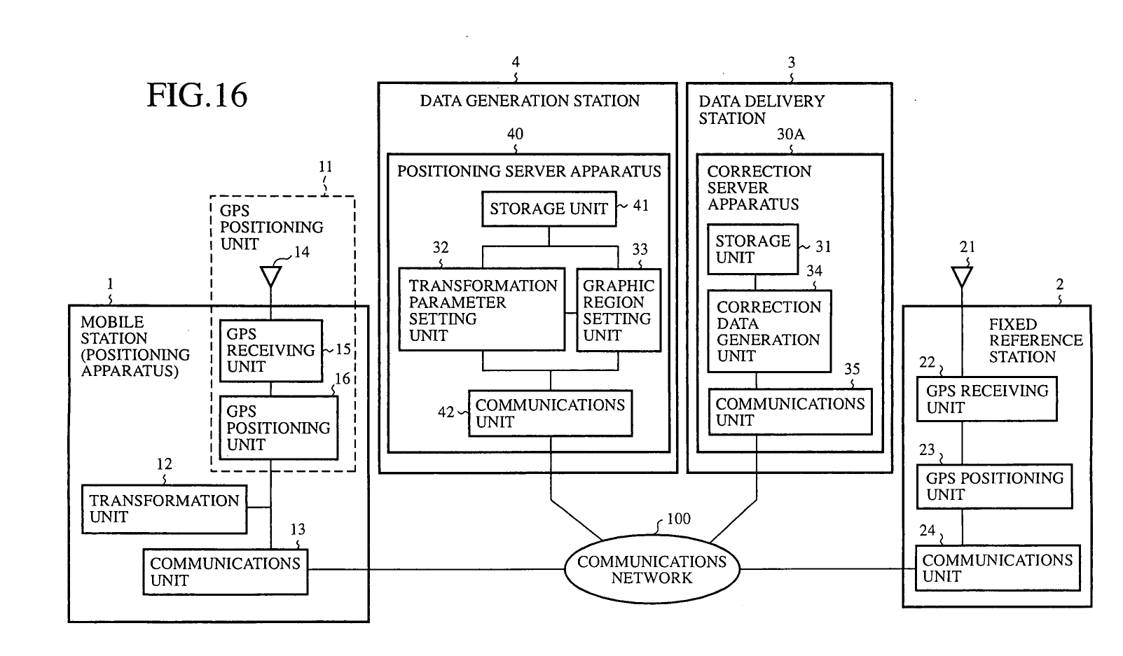

FIG. 16 is a block diagram showing the structure of the positioning system in accordance with embodiment 5 of the present invention. In this positioning system, a mobile station 1 which is a positioning apparatus located at a point to be positioned 101, a fixed reference station 2 disposed at a fixed reference point 102, a correction server apparatus 30A disposed in the data delivery station 3′, and a positioning server apparatus 40 disposed in the data generation station 4 are connected to one another via a communications network 100 which is constructed of a leased line, the Internet, or the like.

The correction server apparatus 30A disposed in the data delivery station 3′ is provided with a storage unit 31, a correction data generation unit 34, and a communications unit 35. The positioning server apparatus 40 disposed in the data generation station 4 is provided with a storage unit 41, a transformation parameter setting unit 32, a graphic region setting unit 33, and a communications unit 42. Thus, the positioning system in accordance with this embodiment 5 includes the data delivery station 3′ and the data generation station 4 into which the data delivery station 3 of above-mentioned embodiment 1 is divided, and the positioning server apparatus 40 disposed in the data generation station 4 into which the transformation parameter setting unit 32 and graphic region setting unit 33 of the data delivery station 3 of above-mentioned embodiment 1 are moved.

Numbers for identifying fixed reference points 102, and the coordinates in the world geodetic system and those in an existing geodetic system of the fixed reference points 102 are stored in the storage unit 31 of the correction server apparatus 30A. In the storage unit 41 of the positioning server apparatus 40, the coordinates in the world geodetic system and those in the existing geodetic system of the fixed reference points 102, the coordinates in the world geodetic system and those in the existing geodetic system of reference points 103, the number of triangular regions included in a transformation triangular network, and numbers for identifying fixed reference points 102 and reference points 103 which constitute each of the triangular regions or the coordinates of the vertices of each of the triangular regions are stored.

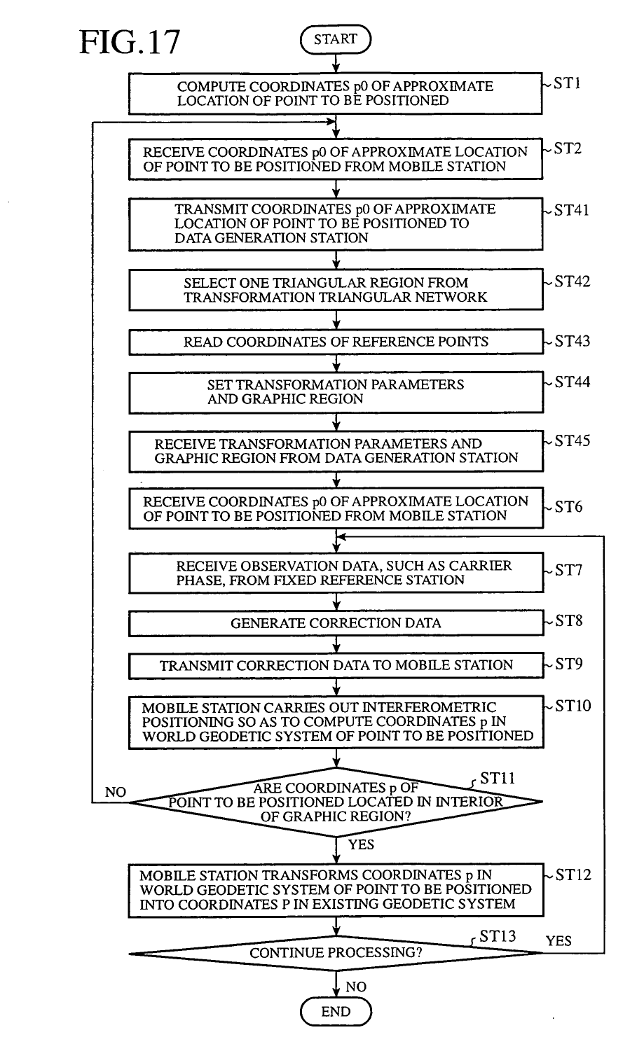

FIG. 17 is a flow chart showing a flow of processing carried out by the positioning system in accordance with embodiment 5 of the present invention. The explanation of the same steps as shown in FIG. 6 of embodiment 1 will be omitted hereafter. The communications unit 35 of the correction server apparatus 30A of the data delivery station 3′, in step ST41, transmits the coordinates p0 of an approximate location of the point to be positioned 101 to the positioning server apparatus 40 of the data generation station 4. The positioning server apparatus 40 carries out steps ST42 to ST44.

The graphic region setting unit 33 of the positioning server apparatus 40 of the data generation station 4, in step ST42, selects one triangular region from the transformation triangular network which is stored in the storage unit 41 and which is created beforehand. This selected triangular region is the one including the coordinates p0 of the approximate location of the point to be positioned 101 received from the mobile station 1 in the interior thereof. The transformation parameter setting unit 32 then, in step ST43, reads the coordinates in the existing geodetic system and those in the world geodetic system of fixed reference points 102 or reference points 103 which are the vertices of the selected triangular region, which are stored in the storage unit 41.

In step ST44, the graphic region setting unit 33 sets a graphic region 201 and the transformation parameter setting unit 32 sets transformation parameters, like those according either of above-mentioned embodiments. In step ST45, the communications unit 42 of the positioning server apparatus 40 transmits the transformation parameters and the graphic region 201 to the correction server apparatus 30A, and the communications unit 35 of the correction server apparatus 30A receives the transformation parameters and the graphic region 201. Thus, the positioning server apparatus 40 disposed in the data generation station 4 receives the coordinates of the approximate location of the point to be positioned 101, as shown in FIG. 4 or 8, from the mobile station 1, and sends the transformation parameters and the graphic region 201, as shown in FIG. 5, 9, or 14, to the mobile station 1.

As mentioned above, in accordance with this embodiment 5 of the present invention, as long as the coordinates in the world geodetic system of the point to be positioned 101, which are computed by the GPS positioning unit 16 of the mobile station 1, are located in the interior of the graphic region 201 set by the graphic region setting unit 33 of the positioning server apparatus 40, the transformation unit 12 of the mobile station 1 transforms the coordinates in the world geodetic system of the point to be positioned 101 into the coordinates in the existing geodetic system of the point using the transformation parameters set by the transformation parameter setting unit 32 of the positioning server apparatus 40. Therefore, the positioning system of this embodiment 5 can use the same transformation parameters for two or more points to be positioned 101, and can compute the location of any point to be positioned 101 with the coordinates in the existing geodetic system of the point, with a high degree of precision and without increasing the amount of traffic in the communications network 100.

In addition, in accordance with this embodiment 5, since the dedicated positioning server apparatus 40 disposed in the data generation station 4 is so constructed as to set the transformation parameters and the graphic region 201, the load on the data delivery station 3′ can be reduced.

### Embodiment 6

A positioning system in accordance with embodiment 6 of the present invention has the same structure as that in accordance with above-mentioned embodiment 5 shown in FIG. 16. In accordance with above-mentioned embodiment 5, the data delivery station 3′ provides an instruction for generating the transformation parameters and the graphic region 201 to the data generation station 4. In contrast, in accordance with this embodiment 6, a mobile station 1 provides an instruction for generating the transformation parameters and the graphic region 201 to a data generation station 4.

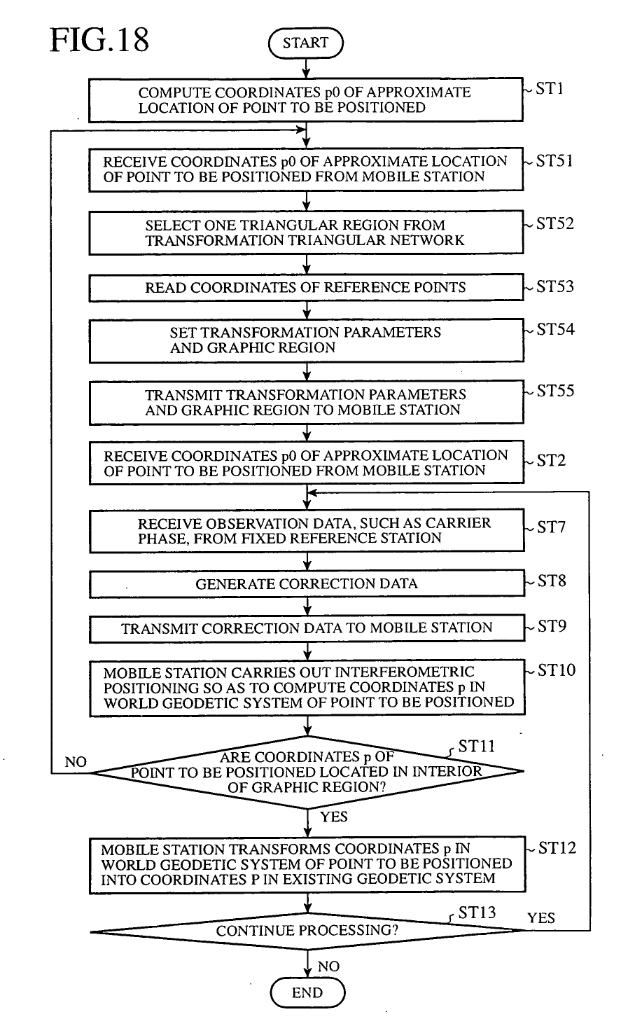

FIG. 18 is a flow chart showing a flow of processing carried out by the positioning system in accordance with embodiment 6 of the present invention. The explanation of the same steps as shown in FIG. 6 of embodiment 1 will be omitted hereafter. Instep ST51, a GPS positioning unit 16 of the mobile station 1 transmits the coordinates p0 of an approximate location of a point to be positioned 101 to a positioning server apparatus 40 of the data generation station 4 via a communications unit 13, and a communications unit 42 of the positioning server apparatus 40 receives the coordinates p0 of the approximate location of the point to be positioned 101. Although these coordinates are the coordinates p0 of the approximate location of the point to be positioned 101 for the first time around, they will be the coordinates p in the world geodetic system for the second or later time.

The positioning server apparatus 40 carries out steps ST52 to ST54. A graphic region setting unit 33 of the positioning server apparatus 40, in step ST52, selects one triangular region from a transformation triangular network which is stored in a storage unit 41 and which is created beforehand. This selected triangular region is the one including the coordinates p0 of the approximate location of the point to be positioned 101 received from the mobile station 1 in the interior thereof. A transformation parameter setting unit 32 then, in step ST53, reads the coordinates in the existing geodetic system and those in the world geodetic system of fixed reference points 102 or reference points 103 which are the vertices of the selected triangular region, which are stored in the storage unit 41.

In step ST54, the graphic region setting unit 33 sets a graphic region 201 and the transformation parameter setting unit 32 sets transformation parameters, like those according either of above-mentioned embodiments. The communications unit 42, in step ST55, transmits the transformation parameters and the graphic region 201 to the mobile station 1. Thus, the positioning server apparatus 40 receives the coordinates p0 of the approximate location of the point to be positioned 101, as shown in FIG. 4 or 8, from the mobile station, and sends the transformation parameters and the graphic region 201, as shown in FIGS. 5, 9, or 14, to the mobile station 1.

As mentioned above, in accordance with this embodiment 6 of the present invention, as long as the coordinates in the world geodetic system of the point to be positioned 101, which are computed by the GPS positioning unit 16 of the mobile station 1, are located in the interior of the graphic region 201 set by the graphic region setting unit 33 of the positioning server apparatus 40, the transformation unit 12 of the mobile station 1 transforms the coordinates in the world geodetic system of the point to be positioned 101 into the coordinates in the existing geodetic system of the point using the transformation parameters set by the transformation parameter setting unit 32 of the positioning server apparatus 40. Therefore, the positioning system of this embodiment 6 can use the same transformation parameters for two or more points to be positioned 101, and can compute the location of any point to be positioned 101 with the coordinates in the existing geodetic system of the point, with a high degree of precision and without increasing the amount of traffic in the communications network 100.

In addition, in accordance with this embodiment 6, the mobile station 1 provides an instruction for setting the transformation parameters and the graphic region 201 directly to the positioning server apparatus 40 of the data generation station 4 without sending the instruction to the correction server apparatus 30A of the data delivery station 3′, and the positioning server apparatus 40 sends the transformation parameters and the graphic region directly to the mobile station 1. Therefore, when not performing the transformation of the coordinates in the world geodetic system of the point to be positioned into the coordinates in the existing geodetic system, the data generation station 4 can eliminate the process of setting the transformation parameters and the graphic region 201, and, even in this case, both the communications between the mobile station 1 and the data delivery station 3′ and the processing done by the data delivery station 3′ remain unchanged and the data delivery station 3′ carries out generation of correction data and delivery operations in the same way as before. Thus, an existing system can be used just as it is.

### Embodiment 7

A positioning system in accordance with embodiment 7 of the present invention has the same structure as that in accordance with above-mentioned embodiment 5 shown in FIG. 16. The positioning system in accordance with above-mentioned embodiment 6 transforms the coordinates in the world geodetic system of the point to be positioned of the mobile station into the coordinates in the existing geodetic system at the time of observation of the point to be positioned 101 by using the GPS. In contrast, the positioning system in accordance with embodiment 7 is so constructed as to collectively carry out the transformation at a later time.

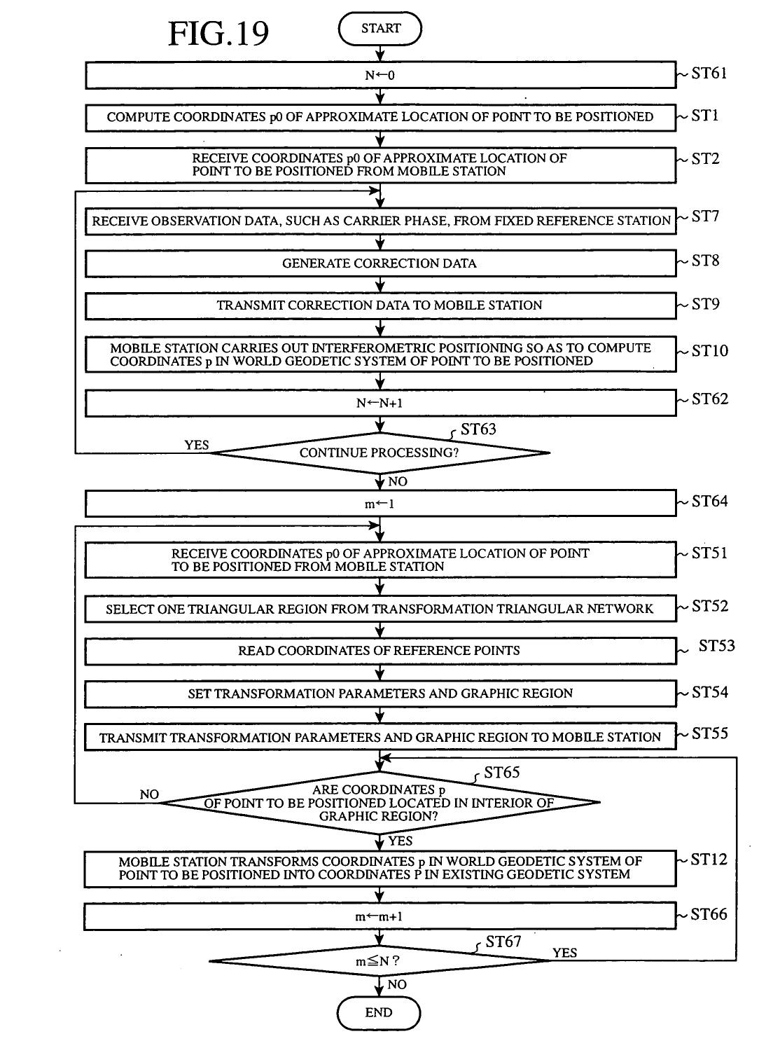

FIG. 19 is a flow chart showing a flow of processing carried out by the positioning system in accordance with embodiment 7 of the present invention. The explanation of the same steps as shown in FIG. 6 of embodiment 1 will be omitted hereafter. In steps ST61 to ST63 of the figure, the positioning system carries out general interferometric positioning using the GPS so as to compute the coordinates p in the world geodetic system of a point to be positioned 101 of a mobile station. The positioning is sequentially performed on all points to be positioned.

A GPS positioning unit 16 of the mobile station 1, in step ST61, initializes a variable N showing the number of all the points to be positioned 101 to 0. A correction data generation unit 34 of a data delivery station 3′ then, in steps ST1 to ST9, generates correction data, and a GPS positioning unit 16 of the mobile station 1, in step ST10, performs the interferometric positioning using the correction data so as to compute the coordinates p in the world geodetic system of the point to be positioned 101 in question. The GPS positioning unit 16 of the mobile station 1 then, in step ST62, adds 1 to the variable N.

The GPS positioning unit 16 of the mobile station 1, in step ST63, determines whether to continue the processing, and, when determining that it continues the processing, returns to step ST7, whereas when determining that it does not continue the processing, it advances to step ST64. After performing step ST63, the number of all the points to be positioned 101 is given by N. A transformation unit 12 of the mobile station 1 then, in step ST64, initializes a variable m to 1. After that, a positioning server apparatus 40 of a data generation station 4 in accordance with this embodiment, in step ST51, receives the coordinates p in the world geodetic system of the m-th point to be positioned 101 from the mobile station 1.

In steps ST52 to step ST55, the data generation station 4 sets transformation parameters and a graphic region 201, and then delivers them to the mobile station 1, like that of above-mentioned embodiment 6. The data generation station 4 receives the coordinates p in the world geodetic system of the point to be positioned 101 in question, and sends the transformation parameters and the graphic region 201, as shown in FIG. 5, 9, or 14, to the mobile station 1.

The transformation unit 12 of the mobile station 1 then, in step ST65, determines whether or not the coordinates p in the world geodetic system of the m-th point to be positioned 101 are located in the interior of the graphic region 201. When the coordinates p in the world geodetic system of the m-th point to be positioned 101 are located in the exterior of the graphic region 201, the positioning system returns to step ST51 in which it causes the mobile station to carry out the processing again. The transformation unit 12 of the mobile station 1, instep ST12, transforms the coordinates p in the world geodetic system of the point to be positioned in question into the coordinates P in the existing geodetic system using the transformation parameters, like that of either of above-mentioned embodiments. The transformation unit 12 of the mobile station 1 then, in step ST66, adds 1 to the variable m. The transformation unit 12, in step ST67, determines whether the processing has been performed on all of the N points to be positioned 101, and, when the processing on all of the N points to be positioned 101 is not completed, returns to step ST65, otherwise, ends the processing.

This embodiment 7 can be applied to a case where another unit is used for the connection among the mobile station 1, the data delivery station 3′, and the data generation station 4. Under present circumstances, the point to be positioned 101 of the mobile station 1 may fall outside a telephone call area for cellular phones in a mountain-ringed region. On the other hand, it is planned that the correction data from the correction server apparatus 30A are piggybacked onto a broadcasting electric wave and are then delivered to the mobile station 1 according to, for example, a method called DGPS (differential GPS), or are delivered to the mobile station 1 from a quasi-zenith satellite that is planned to be launched, and it is therefore expected that the mobile station 1 can be used in a wider area. In this case, the cellular phone becomes connectable after performing the positioning in the world geodetic system using the correction data. That is, the mobile station 1 is connected to the data generation station 4 at a place where it can be connected with the communications network 100, and can transform the coordinates in the world geodetic system of the point to be positioned 101 into the coordinates P in the existing geodetic system by acquiring the transformation parameters and the graphic region 201.

As mentioned above, in accordance with this embodiment 7 of the present invention, as long as the coordinates in the world geodetic system of the point to be positioned 101, which are computed by the GPS positioning unit 16 of the mobile station 1, are located in the interior of the graphic region 201 set by the graphic region setting unit 33 of the positioning server apparatus 40, the transformation unit 12 of the mobile station 1 transforms the coordinates in the world geodetic system of the point to be positioned 101 into the coordinates in the existing geodetic system of the point using the transformation parameters set by the transformation parameter setting unit 32 of the positioning server apparatus 40. Therefore, the positioning system of this embodiment 7 can use the same transformation parameters for two or more points to be positioned 101, and can compute the location of any point to be positioned 101 with the coordinates in the existing geodetic system of the point, with a high degree of precision and without increasing the amount of traffic in the communications network 100.

In addition, in accordance with this embodiment 7, the mobile station 1 collectively computes the coordinates in the world geodetic system of N points to be positioned 101, and, after that, collectively transforms the coordinates in the world geodetic system of the N points to be positioned 101 into the coordinates in the existing geodetic system. Therefore, the user can use the mobile station 1 in a wider area.

Many widely different embodiments of the present invention may be constructed without departing from the spirit and scope of the present invention. It should be understood that the present invention is not limited to the specific embodiments described in the specification, except as defined in the appended claims.

What is claimed is:

1. A positioning apparatus comprising:
a GPS positioning means for computing coordinates of an approximate location of a point to be positioned by receiving electric waves from GPS satellites, for performing interferometric positioning on said point to be positioned using received correction data used for making a correction to said point to be positioned so as to compute coordinates in a world geodetic system of said point to be positioned;
a communications means for transmitting the coordinates of the approximate location of the point to be positioned computed by said GPS positioning means, and for receiving said correction data, transformation parameters used for transforming the coordinates in the world geodetic system of said point to be positioned into coordinates in an existing geodetic system of said point to be positioned, and a graphic region including the coordinates of the approximate location of said point to be positioned; and
a transformation means for transforming the coordinates in the world geodetic system of said point to be positioned into the coordinates in said existing geodetic system of said point to be positioned using the transformation parameters received from said communications means when the coordinates in the world geodetic system of said point to be positioned, which are computed by said GPS positioning means, are located in an interior of the graphic region received from said communications means.

2. The positioning apparatus according to claim 1, wherein said transformation means transforms the coordinates in the world geodetic system of said point to be positioned into the coordinates in the existing geodetic system of said point to be positioned using transformation parameters used for carrying out linear interpolation.

3. The positioning apparatus according to claim 1, wherein said transformation means transforms the coordinates in the world geodetic system of said point to be positioned into the coordinates in the existing geodetic system of said point to be positioned using transformation parameters used for carrying out affine transformation.

4. The positioning apparatus according to claim 1, wherein said transformation means transforms the coordinates in the world geodetic system of said point to be positioned into the coordinates in the existing geodetic system of said point to be positioned using transformation parameters which are a rotation component, a strain component, and a parallel translation component of a strain field in a vicinity of the point to be positioned.

5. The positioning apparatus according to claim 1, wherein said communications means receives a triangular region as the graphic region.

6. The positioning apparatus according to claim 1, wherein said communications means receives a circular region having a center having the coordinates of the approximate location of the point to be positioned, and having a predetermined radius, as the graphic region.

7. A positioning server apparatus comprising:
a storage means for storing information on reference points, the information including both coordinates in a world geodetic system of each of the reference points and coordinates in an existing geodetic system of each of the reference points;
a graphic region setting means for setting a graphic region including coordinates of an approximate location of a point to be positioned using the information on reference points which is stored in said storage means;
a transformation parameter setting means for setting transformation parameters used for transforming coordinates in the world geodetic system of said point to be positioned into coordinates in the existing geodetic system of said point to be positioned using the information on reference points which is stored in said storage means; and
a communications means for receiving the coordinates of the approximate location of said point to be positioned, and for transmitting the graphic region set by said graphic region setting means and the transformation parameters set by said transformation parameter setting means to said point to be positioned.

8. The positioning server apparatus according to claim 7, wherein said transformation parameter setting means sets transformation parameters used for carrying out linear interpolation of a difference between the coordinates in the world geodetic system of said point to be positioned and the coordinates in the existing geodetic system of said point to be positioned.

9. The positioning server apparatus according to claim 7, wherein said transformation parameter setting means sets transformation parameters used for carrying out affine transformation of the coordinates in the world geodetic system of said point to be positioned into the coordinates in the existing geodetic system of said point to be positioned.

10. The positioning server apparatus according to claim 7, wherein said transformation parameter setting means defines a rotation component, a strain component, and a parallel translation component of a strain field in a vicinity of said point to be positioned as transformation parameters used for transforming the coordinates in the world geodetic system of said point to be positioned into the coordinates in the existing geodetic system of said point to be positioned.

11. The positioning server apparatus according to claim 7, wherein said graphic region setting means defines a triangular region whose vertices are reference points as the graphic region.

12. The positioning server apparatus according to claim 7, wherein said graphic region setting means defines a circular region having a center having the coordinates of the approximate location of said point to be positioned and having a predetermined radius as the graphic region.

13. The positioning server apparatus according to Claim 7, further comprising a correction data generation means for generating correction data used for performing interferometric positioning on said point to be positioned based on observation data about two or more reference points from GPS satellites so as to compute the coordinates in the world geodetic system of said point to be positioned, wherein said communications means receives both the coordinates of the approximate location of said point to be positioned and the observation data about said two or more reference points from the GPS satellites, and transmits the correction data set by said correction data generation means, the graphic region set by said graphic region setting means, and the transformation parameters set by said transformation parameter setting means to said point to be positioned.

14. The positioning server apparatus according to claim 13, wherein said transformation parameter setting means sets transformation parameters used for carrying out linear interpolation of a difference between the coordinates in the world geodetic system of said point to be positioned and the coordinates in the existing geodetic system of said point to be positioned.

15. The positioning server apparatus according to claim 13, wherein said transformation parameter setting means sets transformation parameters used for carrying out affine transformation of the coordinates in the world geodetic system of said point to be positioned into the coordinates in the existing geodetic system of said point to be positioned.

16. The positioning server apparatus according to claim 13, wherein said transformation parameter setting means defines a rotation component, a strain component, and a parallel translation component of a strain field in a vicinity of said point to be positioned as transformation parameters used for transforming the coordinates in the world geodetic system of said point to be positioned into the coordinates in the existing geodetic system of said point to be positioned.

17. The positioning server apparatus according to claim 13, wherein said graphic region setting means defines a triangular region whose vertices are reference points as the graphic region.

18. The positioning server apparatus according to claim 13, wherein said graphic region setting means defines a circular region having a center having the coordinates of the approximate location of said point to be positioned and having a predetermined radius as the graphic region.

19. A positioning system provided with a positioning apparatus that computes a location of a point to be positioned with coordinates in an existing geodetic system, and a positioning server apparatus,
said positioning apparatus comprising:
a GPS positioning means for computing coordinates of an approximate location of a point to be positioned by receiving electric waves from GPS satellites, for performing interferometric positioning on said point to be positioned using correction data transmitted from said positioning server apparatus and used for making a correction to said point to be positioned, and for computing coordinates in a world geodetic system of said point to be positioned; a communications means for transmitting the coordinates of the approximate location of the point to be positioned computed by said GPS positioning means to said positioning server apparatus, and for receiving said correction data, transformation parameters used for transforming the coordinates in the world geodetic system of said point to be positioned into coordinates in an existing geodetic system of said point to be positioned, and a graphic region including the coordinates of the approximate location of said point to be positioned from said positioning server apparatus; and a transformation means for transforming the coordinates in the world geodetic system of said point to be positioned into the coordinates in said existing geodetic system of said point to be positioned using the transformation parameters received from said communications means when the coordinates in the world geodetic system of said point to be positioned, which are computed by said GPS positioning means, are located in an interior of the graphic region received from said communications means, and
said positioning server apparatus comprising:
a storage means for storing information on reference points, the information including both coordinates in a world geodetic system of each of the reference points and coordinates in an existing geodetic system of each of the reference points; a correction data generation means for generating correction data used for performing interferometric positioning on said point to be positioned based on observation data about two or more reference points from GPS satellites so as to compute the coordinates in the world geodetic system of said point to be positioned; a graphic region setting means for setting the graphic region including the coordinates of the approximate location of said point to be positioned using the information on reference points which is stored in said storage means; a transformation parameter setting means for setting the transformation parameters used for transforming the coordinates in the world geodetic system of said point to be positioned into the coordinates in the existing geodetic system of said point to be positioned using the information on reference points which is stored in said storage means; and a communications means for receiving both the coordinates of the approximate location of said point to be positioned and the observation data about said two or more reference points from the GPS satellites, and for transmitting the correction data set by said correction data generation means, the graphic region set by said graphic region setting means, and the transformation parameters set by said transformation parameter setting means to said positioning apparatus.
